(19) United States
(12) Patent Application Publication
(10) Pub. No.: US 2026/0292684 A1
(43) Pub. Date: Sep. 24, 2026

(54) LOW POWER SCHEDULING REQUEST

(71) Applicant: QUALCOMM Incorporated, San Diego, CA (US)

(72) Inventors: Jung Ho RYU, Englewood Cliffs, NJ (US); Jelena DAMNJANOVIC, Del Mar, CA (US); Hemant SAGGAR, San Diego, CA (US); Junyi LI, Greentown, PA (US)

(21) Appl. No.: 19/083,614

(22) Filed: Mar. 19, 2025

(51) Int. Cl. H04W 52/02; H04W 72/232

(52) U.S. Cl. CPC H04W 52/0229; H04W 72/232

(57) ABSTRACT

Various aspects of the present disclosure generally relate to wireless communication. In some aspects, a user equipment (UE) may receive, based at least in part on being in an active state, a low power scheduling request (LP-SR) resource allocation. The UE may transition to a sleep state. The UE may transmit an LP-SR using an LP-SR resource in the LP-SR resource allocation. Numerous other aspects are described.

### FIELD OF THE DISCLOSURE

Aspects of the present disclosure generally relate to wireless communication and specifically relate to techniques, apparatuses, and methods associated with a low power scheduling request.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

Connected mode discontinuous reception (C-DRX) is a power saving mechanism in which a user equipment (UE) operating in a connected state transitions between a sleep state and an active state to reduce power consumption. As one example, based at least in part on operating in a sleep state of a C-DRX cycle, the UE may disable or reduce power to a main radio as a power saving mechanism. The UE may transition to an active state for a portion of the C-DRX cycle and, based at least in part on operating in the active state, may enable or increase power to the main radio.

### SUMMARY

The systems, methods, and devices of this disclosure each have several innovative aspects, no single one of which is solely responsible for the desirable attributes disclosed herein.

Some aspects described herein relate to a method of wireless communication performed by a user equipment (UE). The method may include receiving, based at least in part on being in an active state, a low power scheduling request (LP-SR) resource allocation. The method may include transitioning to a sleep state. The method may include transmitting an LP-SR using an LP-SR resource in the LP-SR resource allocation.

Some aspects described herein relate to a method of wireless communication performed by a UE. The method may include receiving, based at least in part on being in an active state, an LP-SR resource allocation. The method may include transitioning to a sleep state. The method may include receiving a low power wakeup signal (LP-WUS) without transmitting an LP-SR. The method may include transitioning to an active state based at least in part on receiving the LP-WUS. The method may include obtaining an uplink data ready indication for an uplink transmission. The method may include transmitting, based at least in part on operating in the active state, a scheduling request (SR) for an uplink grant based at least in part on receiving the uplink data ready indication and without using the LP-SR resource allocation.

Some aspects described herein relate to a method of wireless communication performed by a network node. The method may include transmitting an LP-SR resource allocation that is assigned to a UE and is associated with the UE operating in a sleep state. The method may include receiving an LP-SR in an LP-SR resource in the LP-SR resource allocation.

Some aspects described herein relate to a method of wireless communication performed by a network node. The method may include transmitting an LP-SR resource allocation that is directed to a UE operating in an active state. The method may include transmitting, based at least in part on the UE operating in a sleep state and without receiving an LP-SR, an LP-WUS that instructs the UE to transition to an active state. The method may include receiving, during an active time of the UE, and without using the LP-SR resource allocation, an SR for an uplink grant, the SR being associated with the UE.

Some aspects described herein relate to a non-transitory computer-readable medium that stores a set of instructions for wireless communication by a UE. The set of instructions, when executed by one or more processors of the UE, may cause the UE to receive, based at least in part on being in an active state, an LP-SR resource allocation. The set of instructions, when executed by one or more processors of the UE, may cause the UE to transition to a sleep state. The set of instructions, when executed by one or more processors of the UE, may cause the UE to transmit an LP-SR using an LP-SR resource in the LP-SR resource allocation.

Some aspects described herein relate to a non-transitory computer-readable medium that stores a set of instructions for wireless communication by a UE. The set of instructions, when executed by one or more processors of the UE, may cause the UE to receive, based at least in part on being in an active state, an LP-SR resource allocation. The set of instructions, when executed by one or more processors of the UE, may cause the UE to transition to a sleep state. The set of instructions, when executed by one or more processors of the UE, may cause the UE to receive an LP-WUS without transmitting an LP-SR. The set of instructions, when executed by one or more processors of the UE, may cause the UE to transition to an active state based at least in part on receiving the LP-WUS. The set of instructions, when executed by one or more processors of the UE, may cause the UE to obtain an uplink data ready indication for an uplink transmission. The set of instructions, when executed by one or more processors of the UE, may cause the UE to transmit, based at least in part on operating in the active state, an SR for an uplink grant based at least in part on receiving the uplink data ready indication and without using the LP-SR resource allocation.

Some aspects described herein relate to a non-transitory computer-readable medium that stores a set of instructions for wireless communication by a network node. The set of instructions, when executed by one or more processors of the network node, may cause the network node to transmit an LP-SR resource allocation that is assigned to a UE and is associated with the UE operating in a sleep state. The set of instructions, when executed by one or more processors of the network node, may cause the network node to receive an LP-SR in an LP-SR resource in the LP-SR resource allocation.

Some aspects described herein relate to a non-transitory computer-readable medium that stores a set of instructions for wireless communication by a network node. The set of instructions, when executed by one or more processors of the network node, may cause the network node to transmit an LP-SR resource allocation that is directed to a UE operating in an active state. The set of instructions, when executed by one or more processors of the network node, may cause the network node to transmit, based at least in part on the UE operating in a sleep state and without receiving an LP-SR, an LP-WUS that instructs the UE to transition to an active state. The set of instructions, when executed by one or more processors of the network node, may cause the network node to receive, during an active time of the UE, and without using the LP-SR resource allocation, an SR for an uplink grant, the SR being associated with the UE.

Some aspects described herein relate to a UE. The UE may include a processing system. The processing system may include one or more processors and one or more code-storing memories coupled with the one or more processors. The processing system may be configured to cause the UE to receive, based at least in part on being in an active state, an LP-SR resource allocation. The processing system may be configured to cause the UE to transition to a sleep state. The processing system may be configured to cause the UE to transmit an LP-SR using an LP-SR resource in the LP-SR resource allocation.

Some aspects described herein relate to a UE. The UE may include a processing system. The processing system may include one or more processors and one or more code-storing memories coupled with the one or more processors. The processing system may be configured to cause the UE to receive, based at least in part on being in an active state, an LP-SR resource allocation. The processing system may be configured to cause the UE to transition to a sleep state. The processing system may be configured to cause the UE to receive an LP-WUS without transmitting an LP-SR. The processing system may be configured to cause the UE to transition to an active state based at least in part on receiving the LP-WUS. The processing system may be configured to cause the UE to obtain an uplink data ready indication for an uplink transmission. The processing system may be configured to cause the UE to transmit, based at least in part on operating in the active state, an SR for an uplink grant based at least in part on receiving the uplink data ready indication and without using the LP-SR resource allocation.

Some aspects described herein relate to a network node. The network node may include a processing system. The processing system may include one or more processors and one or more code-storing memories coupled with the one or more processors. The processing system may be configured to cause the network node to transmit an LP-SR resource allocation that is assigned to a UE and is associated with the UE operating in a sleep state. The processing system may be configured to cause the network node to receive an LP-SR in an LP-SR resource in the LP-SR resource allocation.

Some aspects described herein relate to a network node. The network node may include a processing system. The processing system may include one or more processors and one or more code-storing memories coupled with the one or more processors. The processing system may be configured to cause the network node to transmit an LP-SR resource allocation that is directed to a UE operating in an active state. The processing system may be configured to cause the network node to transmit, based at least in part on the UE operating in a sleep state and without receiving an LP-SR, an LP-WUS that instructs the UE to transition to an active state. The processing system may be configured to cause the network node to receive, during an active time of the UE, and without using the LP-SR resource allocation, an SR for an uplink grant, the SR being associated with the UE.

Some aspects described herein relate to an apparatus for wireless communication. The apparatus may include means for receiving, based at least in part on being in an active state, an LP-SR resource allocation. The apparatus may include means for transitioning to a sleep state. The apparatus may include means for transmitting an LP-SR using an LP-SR resource in the LP-SR resource allocation.

Some aspects described herein relate to an apparatus for wireless communication. The apparatus may include means for receiving, based at least in part on being in an active state, an LP-SR resource allocation. The apparatus may include means for transitioning to a sleep state. The apparatus may include means for receiving an LP-WUS without transmitting an LP-SR. The apparatus may include means for transitioning to an active state based at least in part on receiving the LP-WUS. The apparatus may include means for obtaining an uplink data ready indication for an uplink transmission. The apparatus may include means for transmitting, based at least in part on operating in the active state, an SR for an uplink grant based at least in part on receiving the uplink data ready indication and without using the LP-SR resource allocation.

Some aspects described herein relate to an apparatus for wireless communication. The apparatus may include means for transmitting an LP-SR resource allocation that is assigned to a UE and is associated with the UE operating in a sleep state. The apparatus may include means for receiving an LP-SR in an LP-SR resource in the LP-SR resource allocation.

Some aspects described herein relate to an apparatus for wireless communication. The apparatus may include means for transmitting an LP-SR resource allocation that is directed to a UE operating in an active state. The apparatus may include means for transmitting, based at least in part on the UE operating in a sleep state and without receiving an LP-SR, an LP-WUS that instructs the UE to transition to an active state. The apparatus may include means for receiving, during an active time of the UE, and without using the LP-SR resource allocation, an SR for an uplink grant, the SR being associated with the UE.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a diagram illustrating an example of a wireless communication network.

FIG. 2 is a diagram illustrating an example disaggregated network node architecture.

FIGS. 3A, 3B, 3C, and 3D are diagrams illustrating, respectively, a first example of a low power wakeup receiver, a second example of a low power wakeup signal (LP-WUS), a third example of a first LP-WUS procedure, and a fourth example of a second LP-WUS procedure.

FIGS. 4A and 4B are diagrams illustrating a first example and a second example of discontinuous reception.

FIGS. 5A and 5B are diagrams illustrating first example and a second example, respectively, of using an LP-WUS to initiate physical downlink control channel monitoring by a user equipment (UE) operating in a connected mode discontinuous reception mode

FIG. 6 is a diagram illustrating an example of a low power scheduling request procedure.

FIG. 7 is a diagram illustrating an example of a low power wakeup transmitter.

FIG. 8 is a diagram illustrating an example of a wireless communication process between a network node and a UE.

FIG. 9 is a diagram illustrating an example process performed, for example, at a UE or an apparatus of a UE.

FIG. 10 is a diagram illustrating an example process performed, for example, at a UE or an apparatus of a UE.

FIG. 11 is a diagram illustrating an example process performed, for example, at a network node or an apparatus of a network node.

FIG. 12 is a diagram illustrating an example process performed, for example, at a network node or an apparatus of a network node.

FIG. 13 is a diagram of an example apparatus for wireless communication.

FIG. 14 is a diagram of an example apparatus for wireless communication.

### DETAILED DESCRIPTION

Connected mode discontinuous reception (C-DRX) is a power saving mechanism which a user equipment (UE) operating in a connected state transitions between a sleep state and an active state to reduce power consumption. As one example, based at least in part on operating in a sleep state of a C-DRX cycle, the UE may disable or reduce power to a main radio as a power saving mechanism. The UE may transition to an active state for a portion of the C-DRX cycle and, based at least in part on operating in the active state, may enable or increase power to the main radio.

In some cases, C-DRX at the UE may be configured to use a low power wakeup signal (LP-WUS) to decrease power consumption and increase power savings at the UE. As an example, the UE may reduce power consumption by using a low power wakeup receiver (LP-WUR), instead of a main radio, to monitor for an LP-WUS, where the LP-WUR consumes less power relative to the main radio. A network node may transmit an LP-WUS to the UE to indicate whether to start an on-duration timer for an associated discontinuous reception (DRX) cycle (e.g., and transition to an active state) or whether to remain in a sleep state, which may result in the UE extending a sleep state to reduce power consumption further and increase power savings.

In some scenarios, a UE operating in a C-DRX cycle (e.g., transitioning between an active state and a sleep state) may transmit a scheduling request (SR) for an uplink transmission. For instance, in a first scenario, the UE may not be configured to use an LP-WUS and may always transition to an active state for each on-duration in each C-DRX cycle. In such a scenario, transmitting the SR request within an on-duration (or active time) does not increase power consumption at the UE insofar as the UE is already configured to transition to an active state and activate the main radio each on-duration.

In a second scenario, the network node may configure the UE to monitor for an LP-WUS that may trigger the UE to initiate physical downlink control channel (PDCCH) monitoring for a message, or may enable the UE to extend a sleep state (e.g., based at least in part on a lack of an LP-WUS or the LP-WUS indicating to remain in the sleep state). In such a scenario, the UE transmitting an SR during an on-duration or active time may result in increased power consumption and reduced an amount of power savings at the UE that could otherwise be achieved using an LP-WUS. To illustrate, the UE may receive a first LP-WUS that results in the UE transitioning to an active state for a first on-duration or a first active time of a first C-DRX cycle. During the first on-duration, the UE may receive first a PDCCH communication that indicates message for the UE (e.g., a downlink grant) and, based at least in part on being in the active sate, the UE may transmit an SR using the main radio. The UE may then transition to a sleep state at an end of the first active time and for a remainder of the first C-DRX cycle. The UE may receive a second LP-WUS that indicates to monitor for a PDCCH communication, and may transition back to the active state in a second on-duration of a second C-DRX cycle. The UE may receive a second PDCCH communication in the second on-duration, where the second PDCCH communication indicates an uplink grant that is based at least in part on the SR. Accordingly, the UE may transition to the active state at least two times: a first time to transmit an SR for an uplink grant, and a second time to receive and use the uplink grant. The increased number of transitions to the active state may increase power consumption by the UE, resulting in reduced power savings, increased battery drain, and a shortened operating duration of the UE.

Various aspects relate generally to a low power scheduling request (LP-SR). Some aspects more specifically relate to a UE receiving and using an LP-SR resource allocation to transmit an LP-SR. In some aspects, a UE may receive, based at least in part on being in an active state, an LP-SR resource allocation. The UE may transition to a sleep state, such as a sleep state that is associated with a C-DRX cycle. Based at least in part on transitioning to the sleep state, the UE may monitor for an LP-WUS, such as by monitoring for the LP-WUS using an LP-WUR. The UE may transmit an LP-SR using an LP-SR resource in the LP-SR resource allocation. For instance, the UE may monitor a transmit buffer status of a transmit buffer at the UE, and may determine to transmit the LP-SR based at least in part on the transmit buffer status indicating there is uplink data to transmit.

In some aspects, a UE may receive, based at least in part on being in an active state, an LP-SR resource allocation. The UE may transition to a sleep state (e.g., that is associated with a C-DRX cycle) and may receive an LP-WUS without transmitting an LP-SR. For instance, the UE may receive the LP-WUS in an LP-WUS monitoring occasion and using an LP-WUR. The UE may transition to an active state (e.g., as part of an on-duration of a C-DRX cycle) based at least in part on receiving the LP-WUS. The UE may obtain an uplink data ready indication (e.g., from a transmit buffer status) for an uplink transmission, and may transmit, based at least in part on operating in the active state, an SR for an uplink grant based at least in part on receiving the uplink data ready indication and without using the LP-SR resource allocation. That is, the UE may transmit an SR using a main radio, and not an LP-SR using a low power wakeup transmitter (LP-WUT).

In some aspects, a network node may transmit an LP-SR resource allocation that is assigned to a UE, where the LP-SR resource allocation is associated with the UE operating in a sleep state (e.g., a sleep state of a C-DRX cycle). Based at least in part on transmitting the LP-SR resource allocation, the network node may receive an LP-SR in an LP-SR resource in the LP-SR resource allocation.

In some aspects, a network node may transmit an LP-SR resource allocation that is directed to UE operating in an active state. The network node may transmit, based at least in part on the UE operating in a sleep state, an LP-WUS that instructs the UE to transition to an active state. In some aspects, the network node may transmit the LP-WUS without receiving an LP-SR from the UE. The network node may receive, during an active time of the UE and without receiving an LP-SR, an SR for an uplink grant, the SR being associated with the UE. In some aspects, the network node receives the SR without receiving an LP-SR from the UE.

Particular aspects of the subject matter described in this disclosure can be implemented to realize one or more of the following potential advantages. In some examples, by receiving and using an LP-SR resource allocation, the described techniques can be used to enable a UE operating in a sleep state of a C-DRX mode to notify a network node of an uplink grant request via an LP-SR. The UE may transmit the LP-SR using an LP-WUT, and not a main radio, resulting in reduced power consumption and increased power savings at the UE. Alternatively, or additionally, based at least in part on receiving the LP-SR, the network node may coordinate a downlink grant with an uplink grant in a same on-duration of the UE to reduce a number of times the UE transitions to an active state and enables the UE to extend a sleep state for a longer duration. For example, the network node may mitigate the UE waking up for two separate occasions (e.g., a first on-duration in which the UE transmits an SR and a second on-duration in which the UE receives an uplink grant). Reducing the number of times the UE transitions to an active state enabling the UE to extend a sleep state may also result in reduced power consumption and increased power savings at the UE, and the reduced power consumption and the increased power savings at the UE may extend an operating duration of the UE.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

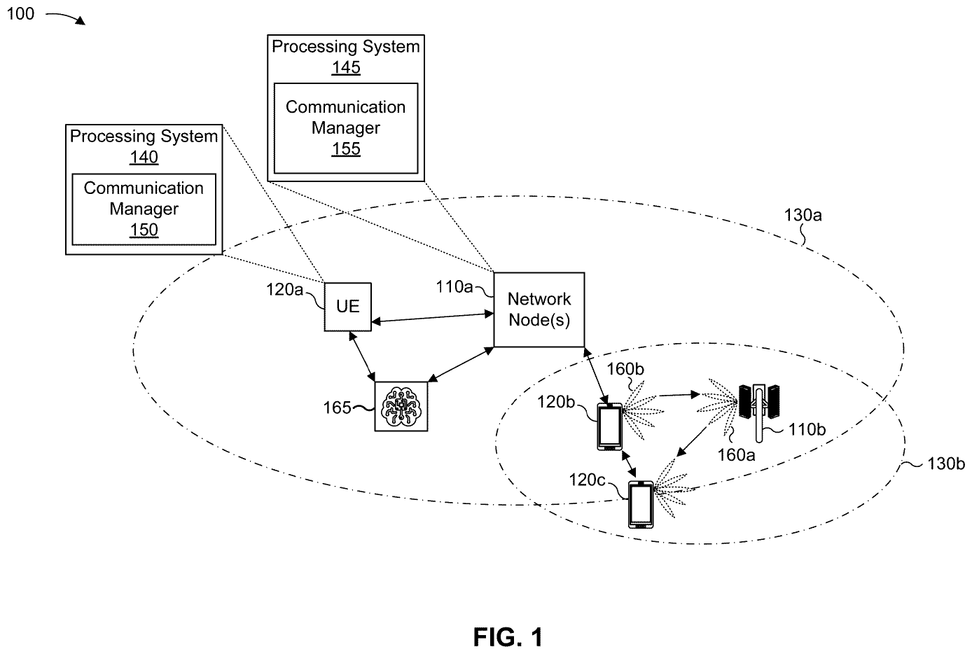

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, and as also shown, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include PDCCHs, and downlink data channels may include physical downlink shared channels (PDSCHs). Control information or data communications may be transmitted on a PDCCH and PDSCH, respectively. For example, a PDCCH can carry DCI, while a PDSCH can carry a MAC-CE, an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include an SR, HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples.

In some aspects, a UE (e.g., a UE 120) may include a communication manager 150. As described in more detail elsewhere herein, the communication manager 150 may receive, based at least in part on being in an active state, an LP-SR resource allocation; transition to a sleep state; and transmit an LP-SR using an LP-SR resource in the LP-SR resource allocation.

Additionally, or alternatively, the communication manager 150 may receive, based at least in part on being in an active state, an LP-SR resource allocation; transition to a sleep state; receive an LP-WUS without transmitting an LP-SR; transition to an active state based at least in part on receiving the LP-WUS; obtain an uplink data ready indication for an uplink transmission; and transmit, based at least in part on operating in the active state, an SR for an uplink grant based at least in part on receiving the uplink data ready indication and without using the LP-SR resource allocation. Additionally, or alternatively, the communication manager 150 may perform one or more other operations described herein.

In some aspects, a network node (e.g., a network node 110) may include a communication manager 155. As described in more detail elsewhere herein, the communication manager 155 may transmit an LP-SR resource allocation that is assigned to a UE and is associated with the UE operating in a sleep state; and receive an LP-SR in an LP-SR resource in the LP-SR resource allocation.

Additionally, or alternatively, the communication manager 155 may transmit an LP-SR resource allocation that is directed to a UE operating in an active state; transmit, based at least in part on the UE operating in a sleep state and without receiving an LP-SR, an LP-WUS that instructs the UE to transition to an active state; and receive, during an active time of the UE, and without using the LP-SR resource allocation, an SR for an uplink grant, the SR being associated with the UE. Additionally, or alternatively, the communication manager 155 may perform one or more other operations described herein.

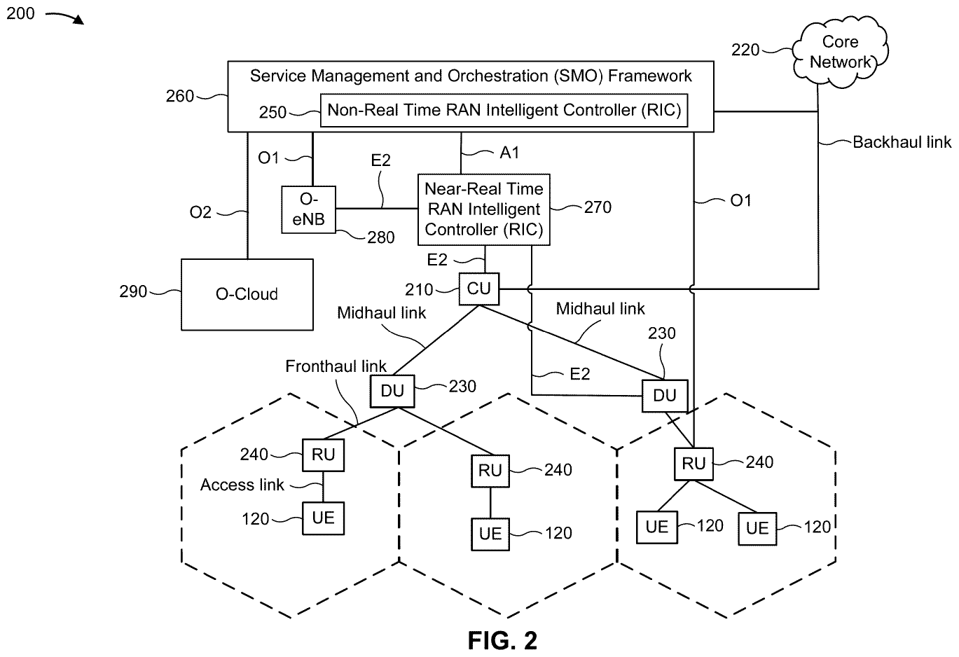

FIG. 2 is a diagram illustrating an example disaggregated network node architecture 200. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for transmitting or receiving signals, such as data, control information, or reference signals via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers.

Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, or a Near-RT RIC 270. In some aspects, the SMO Framework 260 may communicate with a hardware aspect of a 4G RAN, a 5G NR RAN, or a 6G RAN, such as an open eNB (O-eNB) 280, via an O1 interface. Additionally, or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, or policy-based guidance of applications or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

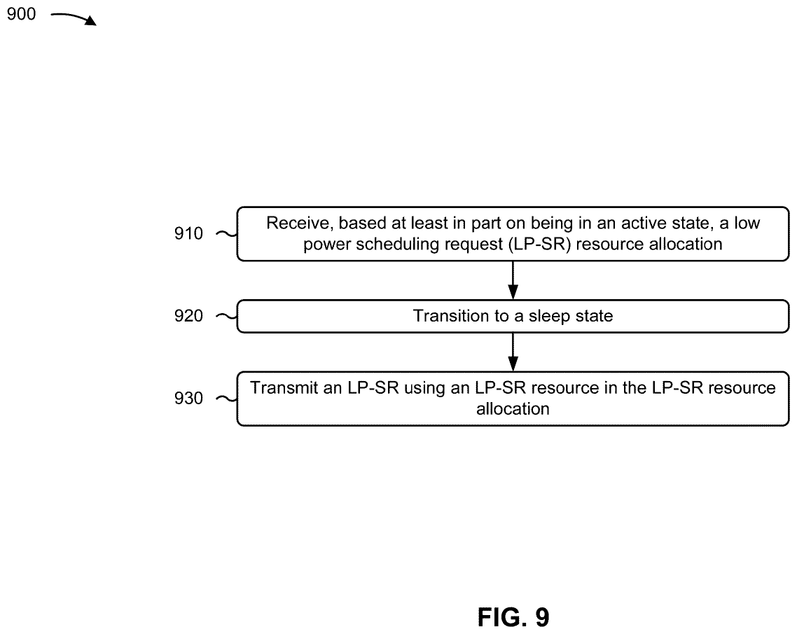

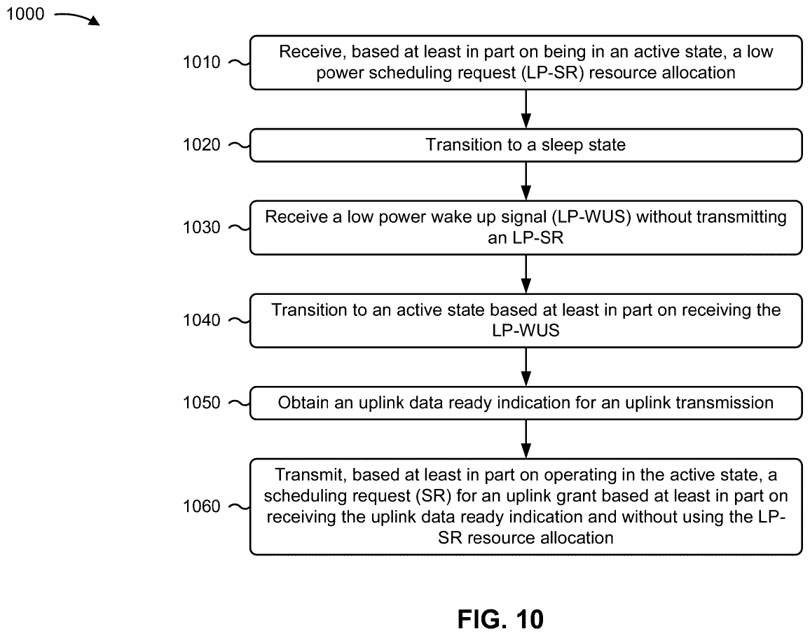

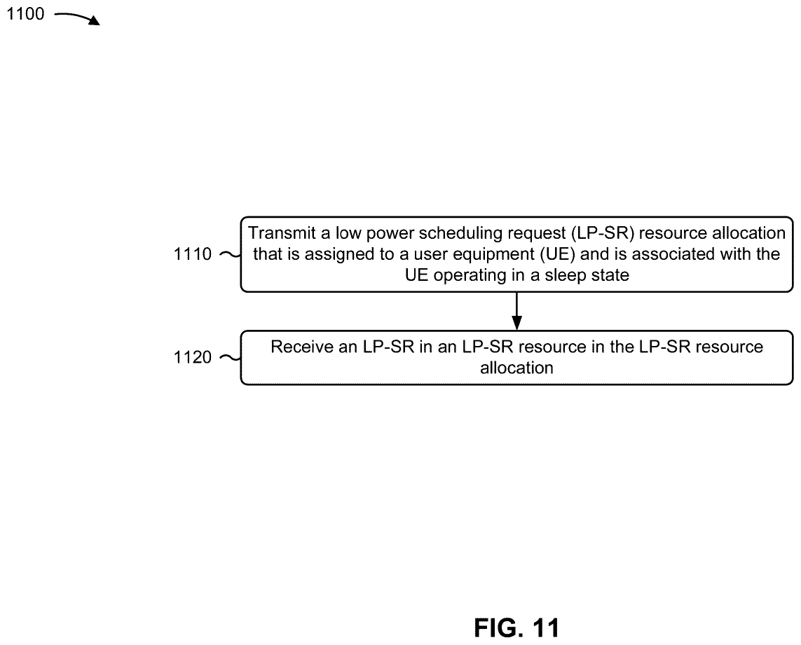

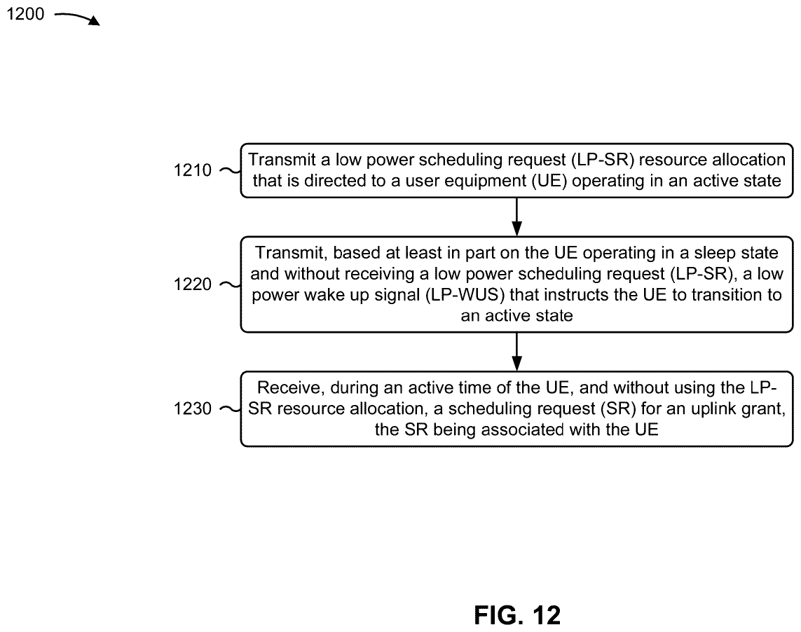

The network node 110, the processing system 145 of the network node 110, the UE 120, the processing system 140 of the UE 120, the CU 210, the DU 230, the RU 240, or any other component(s) of FIG. 1 or FIG. 2 may implement one or more techniques or perform one or more operations associated with an LP-SR, as described in more detail elsewhere herein. For example, the processing system 145 of the network node 110, the processing system 140 of the UE 120, the CU 210, the DU 230, or the RU 240 may perform or direct operations of, for example, process 900 of FIG. 9, process 1000 of FIG. 10, process 1100 of FIG. 11, process 1200 of FIG. 12, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 900 of FIG. 9, process 1000 of FIG. 10, process 1100 of FIG. 11, process 1200 of FIG. 12, or other processes as described herein. In some examples, executing instructions may include running the instructions, converting the instructions, compiling the instructions, or interpreting the instructions, among other examples.

In some aspects, a UE (e.g., a UE 120) includes means for receiving, based at least in part on being in an active state, an LP-SR resource allocation; means for transitioning to a sleep state; or means for transmitting an LP-SR using an LP-SR resource in the LP-SR resource allocation.

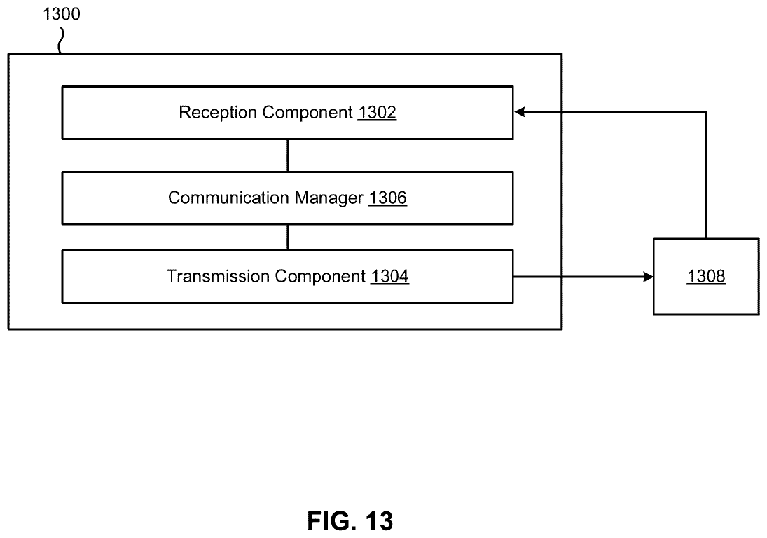

Alternatively, or additionally, the UE includes means for receiving, based at least in part on being in an active state, an LP-SR resource allocation; means for transitioning to a sleep state; means for receiving an LP-WUS without transmitting an LP-SR; means for transitioning to an active state based at least in part on receiving the LP-WUS; means for obtaining an uplink data ready indication for an uplink transmission; or means for transmitting, based at least in part on operating in the active state, an SR for an uplink grant based at least in part on receiving the uplink data ready indication and without using the LP-SR resource allocation. The means for the UE to perform operations described herein may include, for example, one or more of communication manager 150, processing system 140, a radio, one or more RF chains, one or more transceivers, one or more antennas, one or more modems, a reception component (for example, reception component 1302 depicted and described in connection with FIG. 13), or a transmission component (for example, transmission component 1304 depicted and described in connection with FIG. 13), among other examples.

In some aspects, a network node (e.g., a network node 110) includes means for transmitting an LP-SR resource allocation that is assigned to a UE and is associated with the UE operating in a sleep state; or means for receiving an LP-SR in an LP-SR resource in the LP-SR resource allocation.

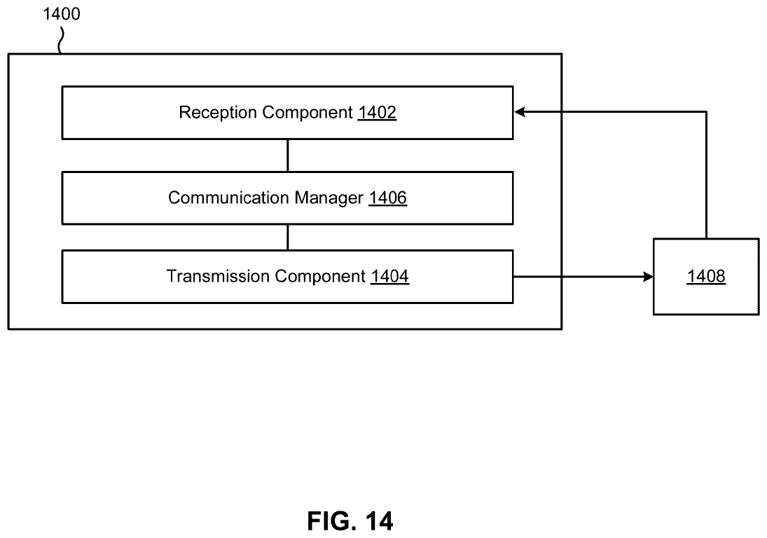

Alternatively, or additionally, the network node includes means for transmitting an LP-SR resource allocation that is directed to a UE operating in an active state; means for transmitting, based at least in part on the UE operating in a sleep state and without receiving an LP-SR, an LP-WUS that instructs the UE to transition to an active state; or means for receiving, during an active time of the UE, and without using the LP-SR resource allocation, an SR for an uplink grant, the SR being associated with the UE. The means for the network node to perform operations described herein may include, for example, one or more of communication manager 155, processing system 145, a radio, one or more RF chains, one or more transceivers, one or more antennas, one or more modems, a reception component (for example, reception component 1402 depicted and described in connection with FIG. 14), or a transmission component (for example, transmission component 1404 depicted and described in connection with FIG. 14), among other examples.

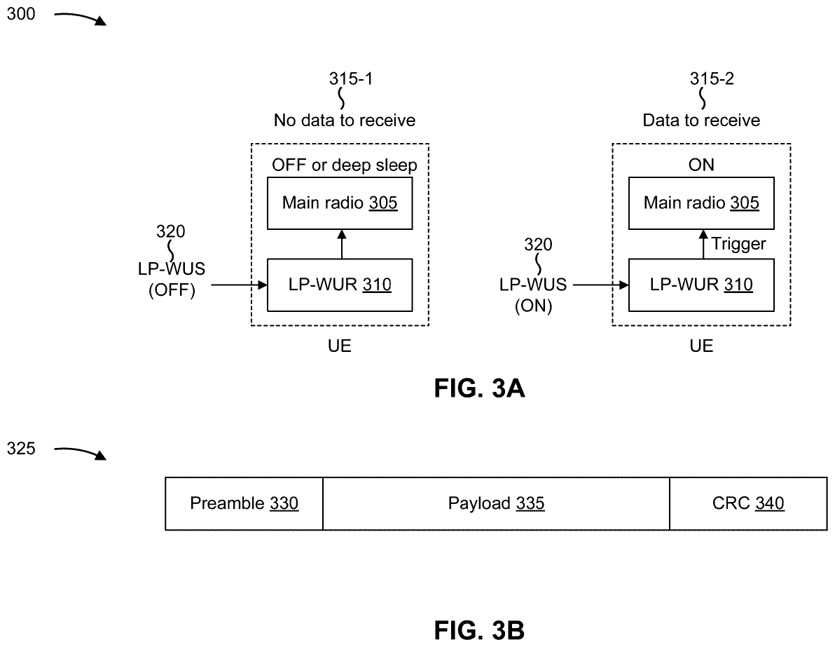

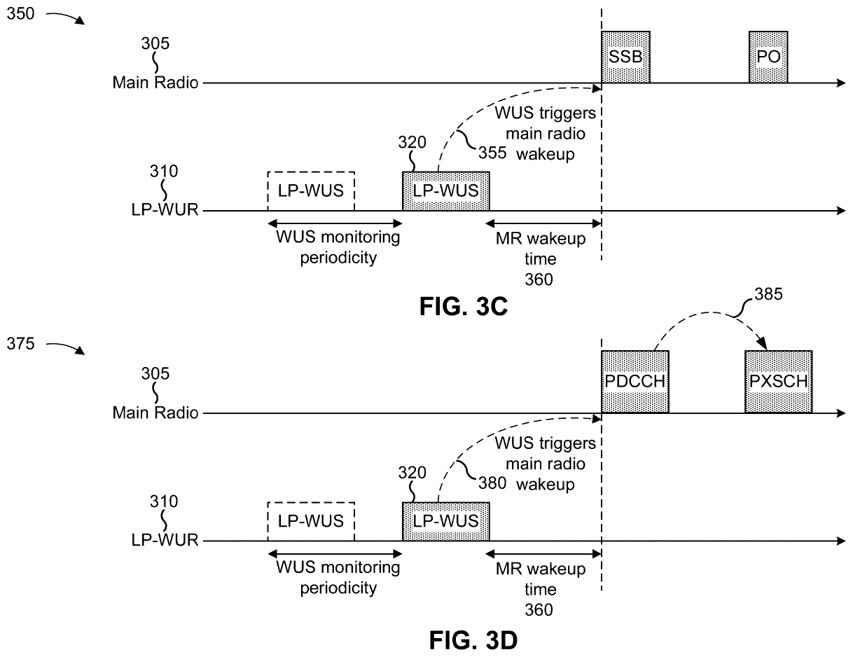

FIGS. 3A, 3B, 3C, and 3D are diagrams illustrating, respectively, a first example 300 of an LP-WUR, a second example 325 of an LP-WUS, a third example 350 of a first LP-WUS procedure, and a fourth example 375 of a second LP-WUS procedure. As shown in FIG. 3A, a UE (such as UE 120) may be equipped with a communication system that includes a main radio (illustrated as “MR”) 305 and an LP-WUR 310 to reduce power consumption and enable low latency. For example, power saving and low latency are often conflicting goals because placing one or more components into a sleep state more often to reduce power consumption also increases latency (e.g., because data cannot be transmitted or received while the one or more components are in the sleep state), and because reducing the time that one or more components spend in a sleep state to reduce latency can lead to increased power consumption. Accordingly, as shown in FIG. 3A, the UE may be equipped with the LP-WUR 310, which may be considered a companion receiver that can be used with a main radio 305 to reduce power consumption and latency.

For example, in some aspects, the UE may generally use the main radio 305 to transmit user data, receive user data, or a combination of the two, and the main radio 305 may be turned off or operated in a deep sleep state unless there is user data to transmit, receive, or a combination of the two. Furthermore, the LP-WUR 310 may serve as a simple wakeup receiver for the main radio 305, and the LP-WUR 310 may be active and monitoring for an LP-WUS while the main radio 305 is off or in the deep sleep state. For example, reference number 315-1 depicts a first state associated with the main radio 305 and the LP-WUR 310 where there is no user data to be provided to the main radio 305. In such cases, the main radio 305 may be off or operated in the deep sleep state unless there is user data to transmit, and the LP-WUR 310 may monitor for an LP-WUS (for example, continuously, or periodically in monitoring occasions that are separated in time). Furthermore, reference number 315-2 depicts a second state associated with the main radio 305 and the LP-WUR 310 where there is user data for the main radio 305. In such cases, the LP-WUR 310 may receive an LP-WUS 320 (such as from a network node 110) and may provide a trigger to wake or otherwise activate the main radio 305 based on detecting the LP-WUS 320. Accordingly, the main radio 305 may then transmit data, receive user data, or a combination of the two.

In general, the LP-WUR 310 may consume very little power (for example a target power consumption less than 100 microwatts (μW) in the active state), which may be achieved using simple modulation schemes (for example, on-off keying (OOK)), a narrow bandwidth (for example, less than 5 MHz), or other suitable techniques. In this way, the LP-WUR 310 can be used to reduce the time that the main radio 305 spends in an on state, may avoid unnecessarily waking the main radio 305 from the off or deep sleep state when there is no user data to transmit or receive, or a combination thereof, which tends to be costly from a power consumption perspective. Furthermore, because the LP-WUR 310 has a very low power consumption, the LP-WUR 310 can be used to frequently or continuously perform LP-WUS monitoring, which may improve latency because the main radio 305 can be woken up when there is user data that the main radio 305 needs to receive. For example, the LP-WUR 310 may not suffer from the latency versus power efficiency tradeoff associated with duty cycling schemes, such as DRX. Furthermore, in addition to performing LP-WUS monitoring, which may be used for paging reception, the LP-WUR 310 may monitor a low power synchronization signal (LP-SS) for time and frequency tracking and radio resource management (RRM) measurement. In this way, by monitoring the LP-SS, serving cell monitoring, neighbor cell monitoring, or a combination of the two, can be offloaded from the main radio 305 to the LP-WUR 310 to reduce how often the main radio 305 is woken up, which can further reduce power consumption.

In some aspects, the LP-WUR 310 may include an OOK WUR (also referred to as an envelope detector (ED) WUR). An OOK WUR may only detect the amplitude (such as the magnitude) of a received signal. A UE that uses an OOK WUR may detect the phase of a received signal by activating the main radio 305.

In some aspects, the LP-WUR 310 may include an OFDM WUR (which may be referred to as an in-phase and quadrature (IQ) WUR). An OFDM WUR can detect both the amplitude and phase of a received signal. For example, an OFDM WUR can obtain first information that is modulated onto a signal using OOK modulation, and second information that is modulated onto the signal using phase modulation.

The first example 300 is an example of an LP-WUR (e.g., the LP-WUR 310) that is a companion receiver to a main radio (e.g., the MR 305), where the LP-WUR includes reduced functionality relative to the main radio and may be used by a UE to reduce power consumption. In a complementary manner to the LP-WUR, a UE may include a low power wakeup transmitter (LP-WUT) that is a companion transmitter to a main radio (e.g., the MR 305). The LP-WUT may include reduced functionality relative to the main radio to enable the UE to reduce power consumption that is associated with transmissions, such as a simplified transmission chain that excludes some components included in the main radio. As one example, an LP-WUT may include an ability to transmit a simple, pre-processed signal (e.g., a pilot signal, a reference signal, or a fixed data pattern) with a reduced bandwidth, and may be unable to transmit a more complex signal that may be transmitted the main radio (e.g., a dynamically modulated and encoded signal that is based on dynamic data). An example LP-WUT is described below with regard to FIG. 7.

The second example 325 shown by FIG. 3B is an example LP-WUS that may be transmitted by a network node 110 and received by a UE 120 as described herein. In some aspects, the network node 110 may transmit the LP-WUS shown by the second example 325 in one or more air interface resources of a resource pool that is dedicated to an LP-WUS (e.g., an RRC configured resource pool that is dedicated to an LP-WUS). As one example, the resource pool may be based at least in part on a paging search space. Alternatively, or additionally, the UE 120 may receive the LP-WUS using an LP-WUR (e.g., the LP-WUR 310) that consumes less power relative to a main radio (e.g., the main radio 305). For instance, a network node may modulate an LP-WUS (e.g., the LP-WUS 320) using a simplified modulation scheme (e.g., relative to OFDM), such as binary phase shift keying (BPSK) or amplitude shift keying (ASK), that enables a UE to implement or use an LP-WUR (e.g., the LP-WUR 310) that consumes less power relative to the main radio. One example ASK modulation scheme is OOK that uses a high signal amplitude, a low signal amplitude, or a combination of the two, to indicate information. To illustrate, in baseband, an OOK waveform may be a sequence of one or more high amplitude durations, one or more low amplitude durations, or any combination thereof. A high signal amplitude in an OOK symbol duration may indicate a first bit value (e.g., “1”) and a low signal amplitude in the OOK symbol duration may indicate a second bit value (e.g., “0”). An LP-WUS may be partitioned into multiple sections or fields, and each section or field may carry different information. For instance, the LP-WUS shown by the second example 325 includes a preamble field 330, a payload field 335, and a cyclic redundancy check (CRC) field 340. The preamble field 330 may be configured with a fixed pattern or a pre-configured pattern of data (e.g., a fixed pattern of bits or a pre-configured pattern of bits), such as “10101010” or “11001100.” The inclusion of the preamble field 330 in the LP-WUS may enable a receiving device (e.g., a UE 120) to identify a presence of an LP-WUS, synchronize to an incoming bit stream included in the LP-WUS, or a combination thereof, such as the payload field 335, the CRC field 340, or both. The payload field 335 may include one or more sub-fields, and each sub-field may be configured to carry respective information. For instance, the payload field 335 may include an identifier field that indicates an intended recipient of the LP-WUS. The CRC field 340 may enable a receiving device to detect whether the received data includes errors or not.

In some examples, an LP-WUS, an LP-SS, or a combination of the two, may be configured as an OOK transmission that is overlaid on an OFDM transmission such that an OOK symbol duration may be based at least in part on an OFDM symbol duration. To illustrate, an LP-WUS may use an OOK-1 waveform in which one bit of information is indicated in a OOK symbol and, subsequently, an OOK symbol duration. Based at least in part on the OOK-1 waveform being overlaid on the OFDM transmission, the OOK symbol duration may be equivalent or commensurate (e.g., within a range of accuracy) to an OFDM symbol duration. As a second example, the LP-WUS may use an OOK-4 waveform in which M bits of information may be indicated in an OOK symbol duration. For a first case in which M=2, two OOK symbols may be transmitted in an OFDM symbol duration such that two OOK symbol durations equate to one OFDM symbol duration. For a second case in which M=4, four OOK symbols may be transmitted in one OFDM symbol duration such that four OOK symbol durations equate to one OFDM symbol duration.

The third example 350 shown by FIG. 3C is a first example LP-WUS procedure that uses the LP-WUR 310. In some aspects, the first example LP-WUS procedure is associated with a UE operating in an idle mode or an inactive mode (e.g., an RRC idle mode or an RRC inactive mode). In the first application, the LP-WUR 310 monitors for the LP-WUS 320. Based at least in part on the UE operating in the idle mode or the inactive mode, receipt of the LP-WUS may indicate to monitor a paging occasion. In such a scenario, the LP-WUS may be used to reduce unnecessary paging reception performed by the main radio 305 and, consequently, conserve power. For example, as shown in FIG. 3C, the LP-WUR 310 may be configured to monitor for an LP-WUS 320 (while the main radio 305 is off or in a deep sleep state) according to a wakeup signal (WUS) monitoring periodicity. That is, the LP-WUR 310 may monitor for the LP-WUS 320 in periodic LP-WUS monitoring occasions that are spaced in time according to the WUS monitoring periodicity. Alternatively, although not explicitly shown in FIG. 3C, the LP-WUR 310 may be configured to continuously monitor for the LP-WUS 320. In general, a network node may transmit an LP-WUS 320 to a UE only in cases where there is a paging message that needs to be sent to the UE while the UE is in the idle mode or the inactive mode. In such cases, the LP-WUR 310 may receive and detect the LP-WUS 320, and, as shown by reference number 355, may trigger the LP-WUR 310 to wake up the main radio 305. In some aspects, the LP-WUS 320 may be a sequence-based WUS, which may include a predefined set of sequences (implemented, for example, using OOK modulation or phase modulation).

As shown by reference number 360, the main radio 305 may wake up after a main radio wakeup time, and may then start to monitor one or more synchronization signal block (SSB) transmissions to obtain synchronization with the network node before monitoring and receiving the paging message in a subsequent PO. In cases where the LP-WUR 310 does not detect the LP-WUS 320, the main radio 305 may remain in the deep sleep state to save power. Example wakeup times may include 12 milliseconds (msec) for a transition out of a light sleep mode and 15 msec for a transition out of a deep sleep mode. Example power consumption by the main radio 305 may include 62 milliamps (mA) while processing a PDCCH with a 20 MHz bandwidth and 2 communication layers, 145 mA for a PUSCH transmission that has a 20 MHz bandwidth, and 1.4 mA while operating in a deep sleep mode.

The fourth example 375 shown by FIG. 3D is a second application of the LP-WUR 310 that is associated with a UE operating in a connected mode (e.g., an RRC connected mode). In a similar manner as the first application described with regard to FIG. 3C, the LP-WUR 310 monitors for the LP-WUS 320. Based at least in part on the UE operating in a connected mode, receipt of the LP-WUS 320 may indicate to monitor a control channel (e.g., a PDCCH) for scheduling information. The use of the LP-WUS 320 for a UE operating in a connected mode may reduce a number of times that the UE operates in an active mode of an associated DRX cycle, which can be used to reduce unnecessary reception performed by the main radio 305. For example, in a similar manner as described with regard to FIG. 3C, the LP-WUR 310 may be configured to monitor for the LP-WUS 320 (while the main radio 305 is off or in a deep sleep state) according to the WUS monitoring periodicity. A network node may transmit an LP-WUS 320 to a UE in scenarios where there is a (pending) control channel message for the UE. In such cases, the network node may transmit the LP-WUS 320, which may be received and detected by the LP-WUR 310. As shown by reference number 380, reception and detection of the LP-WUS 320 may trigger the LP-WUR 310 to wake up the main radio 305. As shown by FIG. 3D, the main radio 305 may wake up after the main radio wakeup time, and may then start to monitor one or more PDCCH monitoring occasions (PMOs). Otherwise, in cases where the LP-WUR 310 does not detect the LP-WUS 320, the main radio 305 may remain in the deep sleep state to save power. In some aspects, the UE may receive scheduling information in PDCCH that occurs during a PMO, and the PDCCH may include scheduling information for a PDSCH transmission or a PUSCH transmission (shown by FIG. 3D as PXSCH) as shown by reference number 385.

As indicated above, FIGS. 3A, 3B, 3C, and 3D are provided as examples. Other examples may differ from what is described with regard to FIGS. 3A, 3B, 3C, and 3D.

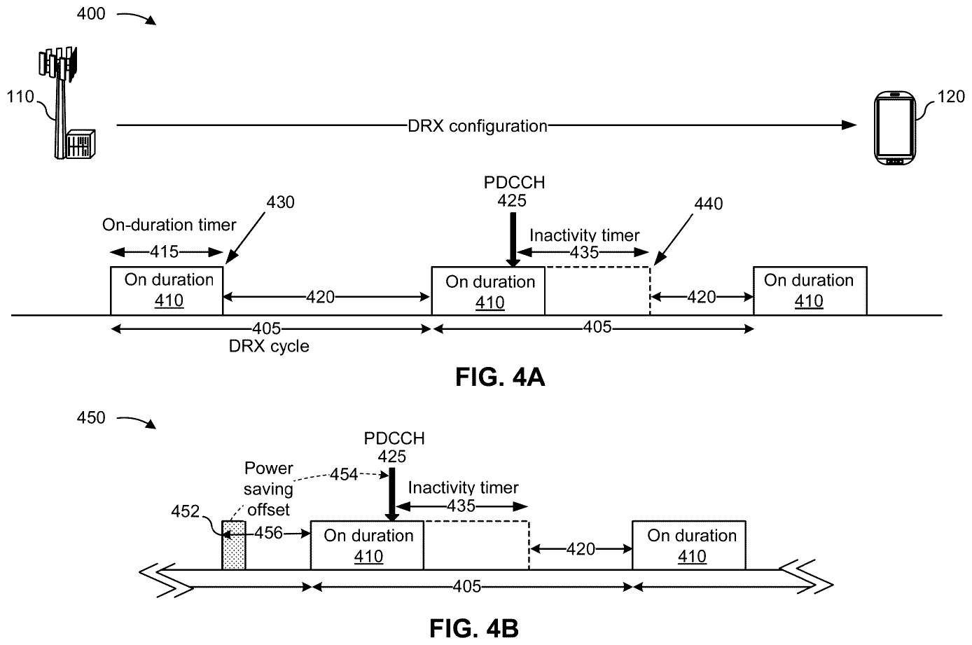

FIGS. 4A and 4B are diagrams illustrating a first example 400 and a second example 450 of discontinuous reception (DRX).

In the first example 400 shown by FIG. 4A, a network node 110 may transmit a DRX configuration to a UE 120 to configure a DRX cycle 405 for the UE 120. A DRX cycle 405 may include a DRX on-duration 410 (e.g., during which a UE 120 is awake or in an active state) and an opportunity to enter a DRX sleep state 420. As used herein, the time during which the UE 120 is configured to be in an active state during the DRX on-duration 410 may be referred to as an active time, and the time during which the UE 120 is configured to be in the DRX sleep state 420 may be referred to as an inactive time. As described below, the UE 120 may monitor a PDCCH during the active time, and may refrain from monitoring the PDCCH during the inactive time. In some aspects, the DRX on-duration 410 may be based at least in part on an on-duration timer 415 (e.g., a drx-onDurationTimer). Alternatively, or additionally, the DRX on-duration 410 may begin after an offset that is relative to a start of a time partition. For example, the DRX on-duration 410 may begin after a slot offset that is relative to a start of a time slot.

During the DRX on-duration 410 (e.g., the active time), the UE 120 may monitor a downlink control channel (e.g., a PDCCH), as shown by reference number 425. For example, the UE 120 may monitor the PDCCH for DCI pertaining to the UE 120. If the UE 120 does not detect or successfully decode any PDCCH communications intended for the UE 120 during the DRX on-duration 410, then the UE 120 may enter the sleep state 420 (e.g., for the inactive time) at the end of the DRX on-duration 410, as shown by reference number 430. In this way, the UE 120 may conserve battery power and reduce power consumption. As shown, the DRX cycle 405 may repeat with a configured periodicity according to the DRX configuration.

If the UE 120 detects or successfully decodes a PDCCH communication intended for the UE 120, then the UE 120 may remain in an active state (e.g., awake) for the duration of a DRX inactivity timer 435 (e.g., which may extend the active time). The UE 120 may start the DRX inactivity timer 435 at a time at which the PDCCH communication is received (e.g., in a transmission time interval (TTI) in which the PDCCH communication is received, such as a slot or a subframe). The UE 120 may remain in the active state until the DRX inactivity timer 435 expires, at which time the UE 120 may enter the sleep state 420 (e.g., for the inactive time), as shown by reference number 440. During the duration of the DRX inactivity timer 435, the UE 120 may continue to monitor for PDCCH communications, may obtain a downlink data communication (e.g., on a downlink data channel, such as a PDSCH) scheduled by the PDCCH communication, may prepare and transmit an uplink communication (e.g., on a PUSCH) scheduled by the PDCCH communication, or a combination of the two. The UE 120 may restart the DRX inactivity timer 435 after each detection of a PDCCH communication for the UE 120 for an initial transmission (e.g., but not for a retransmission). By operating in this manner, the UE 120 may conserve battery power and reduce power consumption by entering the sleep state 420.

The second example 450 shown by FIG. 4B is an example of connected mode discontinuous reception (C-DRX) that is configured with downlink control information with cyclic redundancy check scrambled by a power saving radio network temporary identifier (DCP) as a WUS to decrease power consumption by a UE 120 and increase power savings at the UE 120. That is, the C-DRX cycle may use a DCP as a wakeup signal. As an example, a network node 110 may transmit a DCP to a UE 120 that is operating in a C-DRX mode to indicate whether to start an on-duration timer (e.g., a drx-onDurationTimer) for an associated DRX cycle (e.g., and transition to an active state) or whether to remain in a sleep state.

To illustrate, in a similar manner as described with regard to FIG. 4A, a network node 110 may transmit a DRX configuration to a UE 120 that configures C-DRX operation at the UE 120, such as by configuring any combination of a DRX cycle used by the UE 120 (e.g., the DRX cycle 405), a DRX on-duration (e.g., the DRX on-duration 410), a DRX sleep state (e.g., the DRX sleep state 420), or any combination thereof. In some aspects, the DRX configuration may indicate a DCP state, such as an enabled DCP state that indicates that the C-DRX mode uses DCP signaling aor a disabled DCP state that indicates that the C-DRX mode does not use DCP signaling.

Based at least in part on operating in a C-DRX mode, the UE 120 may monitor PDCCH that is associated with a serving cell (e.g., the network node 110) during an active time (e.g., the DRX on-duration 410) and may operate in a sleep state outside of the active time in a similar manner as described with regard to FIG. 4A. The active time may be based at least in part on an on-duration timer (e.g., the on-duration timer 415) and, in some cases, an inactivity timer (e.g., the inactivity timer 435). In some cases, the UE 120 may remain in a sleep state instead of transitioning to an active state for the on-duration 410 based at least in part on the C-DRX mode being configured with an enabled DCP state.

For example, the network node 110 may transmit a DCP 452 (shown with a dotted pattern) as a wakeup signal that indicates whether the UE 120 should monitor for PDCCH during the DRX on-duration 410 as shown by reference number 454, or whether to remain in a sleep state. In some cases, the network node 110 may transmit the DCP 452 using a power saving offset 456 that may be based at least in part on a start of a search time for the DCP 452 and a start of the DRX on-duration 410. Example values for the power saving offset 456 may include multiples of 0.125 milliseconds (msec), such as 0.125 msec, 0.25 msec, or 0.375 msec. Based at least in part on the DCP 452 being carried in PDCCH, the UE 120 may use a main radio (e.g., the main radio 305) to receive and decode the DCP 452. Relative to monitoring PDCCH in the DRX on-duration 410, the UE 120 may consume less power via the main radio to receive and decode the DCP 452. Accordingly, a DCP 452 that indicates to remain in a sleep state may enable the UE 120 keep the main radio in a sleep state during the DRX on-duration 410 and, consequently, reduce power consumption.

As indicated above, FIGS. 4A and 4B are provided as examples. Other examples may differ from what is described with respect to FIGS. 4A and 4B.

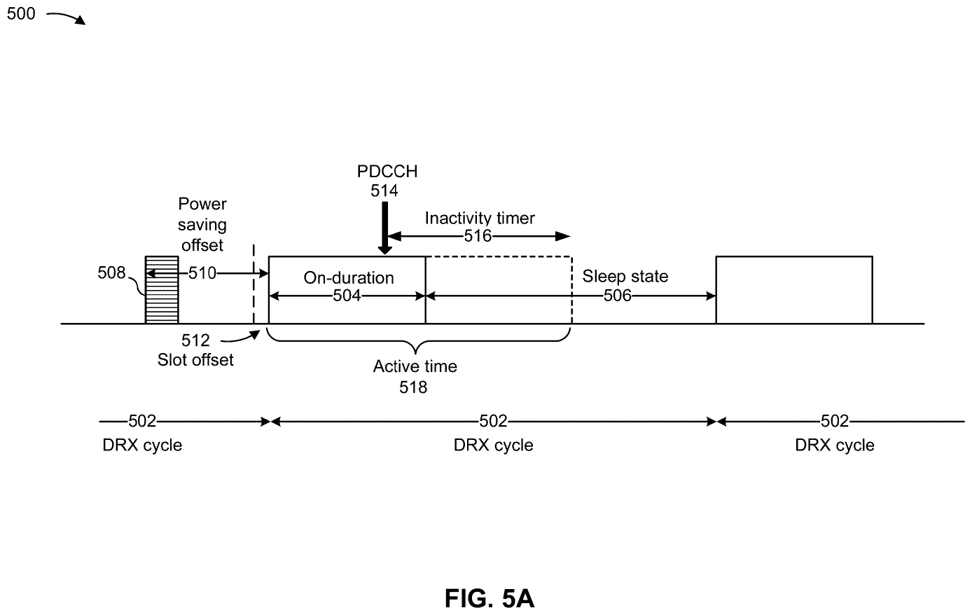

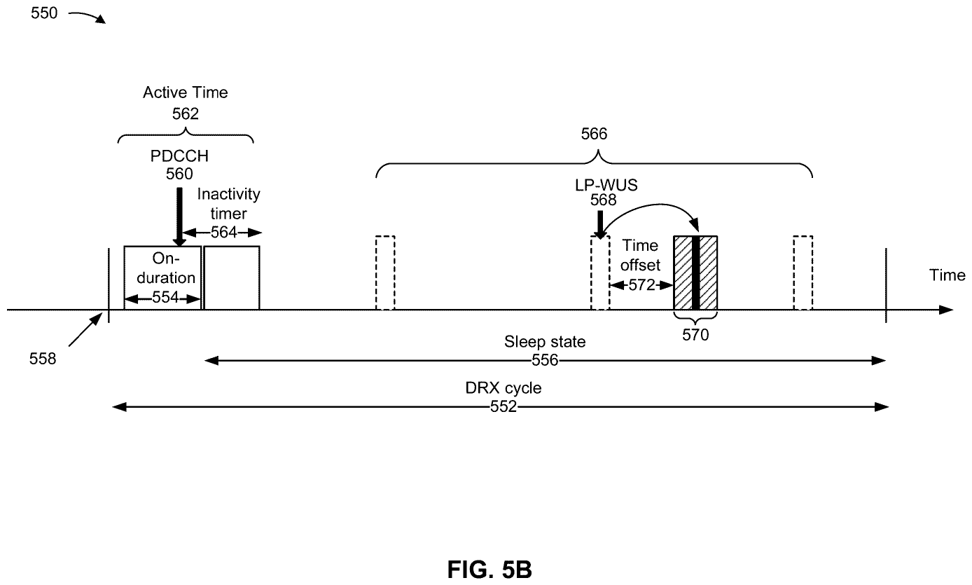

FIGS. 5A and 5B are diagrams illustrating first example 500 and a second example 550, respectively, of using an LP-WUS to initiate PDCCH monitoring by a UE operating in a C-DRX mode.

As an alternative to a DCP as described with regard to FIG. 4B, a network node (e.g., a network node 110) may transmit an LP-WUS that is directed to a UE (e.g., UE 120) that is operating in a C-DRX mode to trigger the UE to initiate or begin PDCCH monitoring. To illustrate, as a first option of using an LP-WUS to trigger a UE to initiate PDCCH monitoring, the network node may transmit an LP-WUS in a similar manner as described with regard to the DCP 452 described with regard to FIG. 4B. That is, in the first option, the network node may replace the DCP 452 with an LP-WUS, and may transmit the LP-WUS prior to a start time associated with an on-duration timer (e.g., a drx-onDurationTimer) for an associated DRX cycle to indicate to start an on-duration timer (and transition to an active state), and a lack of an LP-WUS prior to the on-duration timer may indicate to remain in a sleep state. Transmission and detection of the LP-WUS may be based at least in part on a power saving offset (e.g., the power saving offset 456) that is associated with a start of a search time for the LP-WUS and a start of an on-duration.

To illustrate, the first example 500 shown by FIG. 5A is an example of a C-DRX cycle 502 of a UE (e.g., a UE 120), and signaling that may be used to trigger the UE to initiate PDCCH monitoring. For example, in a similar manner as described with regard to FIG. 4A and FIG. 4B, a network node 110 may transmit a DRX configuration to a UE 120 that configures C-DRX operation at the UE 120, such as by configuring any combination of a DRX cycle used by the UE 120 (e.g., the DRX cycle 502), a DRX on-duration (e.g., a DRX on-duration 504), a DRX sleep state (e.g., a DRX sleep state 506), or any combination thereof. A starting subframe of the DRX cycle 502 may be indicated or derived from a configuration parameter in the DRX configuration, such as a drx-LongCycleStartOffset configuration parameter.

The UE 120 may monitor a PDCCH that is associated with a serving cell during an active time (e.g., the DRX on-duration 504) and may operate in a sleep state outside of the active time in a similar manner as described with regard to FIGS. 4A and 4B. In some cases, the UE 120 may remain in a sleep state instead of transitioning to an active state for the on-duration 410 based at least in part on the C-DRX mode being configured with an enabled DCP state. Alternatively, the UE 120 may remain in the sleep state, instead of transitioning to an active state for the on-duration 504, based at least in part on the DRX configuration indicating an enabled LP-WUS state.

A network node may transmit an LP-WUS (shown with horizontal stripes) that indicates or instructs the UE 120 to initiate monitoring for a PDCCH communication during the DRX on-duration 504. In some cases, the network node may transmit the LP-WUS using a power saving offset 510 that may be based at least in part on any combination of a start of a search time for the LP-WUS 508, a start of the DRX on-duration 504, or a slot offset 512. The UE may receive the LP-WUS 508 using an LP-WUR, such as the LP-WUR 310 described with regard to FIG. 3A, and, based at least in part on receiving the LP-WUS 508, the UE may activate a main radio (e.g., the main radio 305) to monitor for a PDCCH communication. As an example, the UE may monitor for a PDCCH communication from a serving network node. In a similar manner as described with regard to FIG. 4B, based at least in part on successfully detecting and decoding a PDCCH communication 514 that is directed to the UE, the UE may remain in the active state for the duration of a DRX inactivity timer 516. For instance, as shown by FIG. 5A, the UE may remain in the active state for an active time 518, where the active time 518 is based on the on-duration 504 as monitored by an on-duration timer (e.g., a drx-onDurationTimer) and an inactive timer (e.g., a drx-InactivityTimer) that may be indicated in the DRX configuration. The PDCCH communication 514 may indicate scheduling information for any combination of a downlink transmission, an uplink transmission, or a sidelink transmission.

In a second option for using an LP-WUS to trigger a UE to initiate PDCCH monitoring, a network node may transmit, and a UE may monitor for, an LP-WUS based at least in part on an LP-WUS monitoring configuration, such as an LP-WUS monitoring configuration that is RRC-configured by the network node. In some cases, the use of an LP-WUS monitoring configuration may be irrespective of an on-duration timer, such that transmission and monitoring occasions are derived from the LP-WUS monitoring configuration and not using knowledge of a start of an on-duration timer. That is, LP-WUS transmission and LP-WUS monitoring may occur outside of a C-DRX active time and as specified by an LP-WUS monitoring configuration.

To illustrate, the second example 550 sown by FIG. 5B is an example of a C-DRX cycle 552 of a UE (e.g., a UE 120), and signaling that triggers the UE to initiate PDCCH monitoring. In a similar in a similar manner as described with regard to FIG. 4A, FIG. 4B, and FIG. 5A, a network node 110 may transmit a DRX configuration to a UE 120 that configures C-DRX operation at the UE 120, such as by configuring any combination of a DRX cycle used by the UE 120 (e.g., the DRX cycle 552), a DRX on-duration (e.g., a DRX on-duration 554), and a DRX sleep state (e.g., a DRX sleep state 556). A starting subframe of the DRX cycle 552 (shown by reference number 558) may be indicated or derived from a configuration parameter in the DRX configuration, such as a drx-LongCycleStartOffset configuration parameter. Based at least in part on receiving a PDCCH communication 560 within the on-duration 554, the UE may remain in an active state for an active time 562 that is associated with an on-duration timer (e.g., a drx-onDurationTimer) and an inactivity timer 564 (e.g., a drx-InactivityTimer) that may be indicated in the DRX configuration.

As shown by reference number 566, a UE may be configured with one or more LP-WUS monitoring occasions (shown with dotted lines) that occur outside of the active time 562. As described above, the LP-WUS monitoring occasions may be configured via an LP-WUS monitoring configuration (e.g., via RRC signaling). The UE may monitor for an LP-WUS in each respective LP-WUS using an LP-WUR and, based at least in part on detecting an LP-WUS 568 in one of the LP-WUS monitoring occasions, the UE may activate a main radio and begin monitoring for a PDCCH communication. A PDCCH monitoring window 570 (shown with diagonal strips) may be based at least in part on a time offset 572 that is associated with receipt of the LP-WUS. In a similar manner as the LP-WUS monitoring occasions, the PDCCH monitoring window 570 may be located outside of the active time 562. A duration of the PDCCH monitoring window 570 may be based at least in part on a configured timer that is indicated in the DRX configuration.

With regard to the second example 550 shown by FIG. 5B, LP-WUS monitoring that is configured via an LP-WUS monitoring configuration may be conditional on the LP-WUS monitoring configuration positioning the LP-WUS monitoring occasion(s) prior to an on-duration timer of the upcoming DRX cycle to ensure that the UE begins monitoring for a PDCCH communication prior to a start of an on-duration timer of the upcoming DRX cycle. That is, the use of an LP-WUS monitoring configuration to specify one or more LP-WUS monitoring occasions may be subject to a stipulation that the LP-WUS monitoring occasion(s) occur prior to an on-duration of the upcoming DRX cycle. However, as a first configuration of the second example 550, PDCCH monitoring may additionally be triggered based at least in part on a start time of an on-duration timer. To achieve a power saving gain that is associated with the use of an LP-WUS, some LP-WUS monitoring configurations may align an LP-WUS monitoring occasion (and LP-WUS transmission occasion) in a similar manner as described with regard to the first example (e.g., replacing a DCP with an LP-WUS). As a second configuration of the second example 550, and based at least in part on using an LP-WUS to trigger PDCCH monitoring, a UE may not be triggered to initiate PDCCH monitoring based at least in part on the start time of the on-duration timer. That is, the UE may perform LP-WUS independent of the on-duration timer 554 (e.g., not during the active time 562).

In some scenarios, a UE may interrupt a sleep state of a C-DRX cycle to transmit an SR for an uplink transmission. To increase a power savings gain at the UE operating with an enabled C-DRX mode, a network node 110 may configure the UE to transmit an SR within an on-duration or an active time of the UE. For instance, in a first scenario, the UE may not be configured to use an LP-WUS and may always transition to an active state for each on-duration in each C-DRX cycle. In such a scenario, transmitting the SR within the active time does not increase power consumption at the UE insofar as the UE is already configured to transition to an active state and activate the main radio during each on-duration.

In a second scenario, the network node may configure the UE to monitor for an LP-WUS that may trigger the UE to initiate PDCCH monitoring for a message, or may enable the UE to extend a sleep state (e.g., based at least in part on a lack of an LP-WUS or the LP-WUS indicating to remain in the sleep state). In such a scenario, the UE transmitting an SR during an on-duration or an active time may result in increased power consumption and reduce an amount of power savings at the UE that could otherwise be achieved using an LP-WUS. To illustrate, the UE may receive a first LP-WUS that results in the UE transitioning to an active state for a first on-duration or a first active time of a first C-DRX cycle. During the first on-duration, the UE may receive a first PDCCH communication that indicates a message for the UE (e.g., a downlink grant) and, based at least in part on being in the active sate, the UE may transmit an SR using the main radio. The UE may then transition to a sleep state at an end of the first active time and for a remainder of the first C-DRX cycle. The UE may receive a second LP-WUS that indicates to monitor for a PDCCH communication, and may transition back to the active state in a second on-duration of a second C-DRX cycle. The UE may receive a second PDCCH communication in the second on-duration, where the second PDCCH communication indicates an uplink grant that is based at least in part on the SR. Accordingly, the UE may transition to the active state at least two times: a first time to transmit an SR for an uplink grant, and a second time to receive and use the uplink grant. The increased number of transitions to the active state may increase power consumption by the UE, resulting in reduced power savings, increased battery drain, and a shortened operating duration of the UE.

Various aspects relate generally to an LP-SR. Some aspects more specifically relate to a UE receiving and using an LP-SR resource allocation to transmit an LP-SR. In some aspects, a UE may receive, based at least in part on being in an active state, an LP-SR resource allocation. The UE may transition to a sleep state, such as a sleep state that is associated with a C-DRX cycle. Based at least in part on transitioning to the sleep state, the UE may monitor for an LP-WUS, such as by monitoring for the LP-WUS using an LP-WUR. The UE may transmit an LP-SR using an LP-SR resource in the LP-SR resource allocation. For instance, the UE may monitor a transmit buffer status of a transmit buffer at the UE, and may determine to transmit the LP-WUS based at least in part on the transmit buffer status indicating there is uplink data to transmit.

In some aspects, a UE may receive, based at least in part on being in an active state, an LP-SR resource allocation. The UE may transition to a sleep state (e.g., that is associated with a C-DRX cycle) and may receive an LP-WUS without transmitting an LP-SR. For instance, the UE may receive the LP-WUS in an LP-WUS monitoring occasion and using an LP-WUR. The UE may transition to an active state (e.g., as part of an on-duration of a C-DRX cycle) based at least in part on receiving the LP-WUS. The UE may obtain an uplink data ready indication (e.g., from a transmit buffer status) for an uplink transmission, and may transmit, based at least in part on operating in the active state, an SR for an uplink grant based at least in part on receiving the uplink data ready indication and without using the LP-SR resource allocation. That is, the UE may transmit an SR using a main radio, and not an LP-SR using an LP-WUT.

In some aspects, a network node may transmit an LP-SR resource allocation that is assigned to a UE, where the LP-SR resource allocation is associated with the UE operating in a sleep state (e.g., a sleep state of a C-DRX cycle). Based at least in part on transmitting the LP-SR resource allocation, the network node may receive an LP-SR in an LP-SR resource in the LP-SR resource allocation.

In some aspects, a network node may transmit an LP-SR resource allocation that is directed to UE operating in an active state. The network node may transmit, based at least in part on the UE operating in a sleep state, an LP-WUS that instructs the UE to transition to an active state. In some aspects, the network node may transmit the LP-WUS without receiving an LP-SR from the UE. The network node may receive, during an active time of UE and without receiving an LP-SR, an SR for an uplink grant, the SR being associated with the UE. In some aspects, the network node receives the SR without receiving an LP-SR from the UE.

Particular aspects of the subject matter described in this disclosure can be implemented to realize one or more of the following potential advantages. In some examples, by receiving and using an LP-SR resource allocation, the described techniques can be used to enable a UE operating in a sleep state of a C-DRX mode to notify a network node of an uplink grant request via an LP-SR. The UE may transmit the LP-SR using an LP-WUT, and not a main radio, resulting in reduced power consumption and increased power savings at the UE. Alternatively, or additionally, based at least in part on receiving the LP-SR, the network node may coordinate a downlink grant with an uplink grant in a same on-duration of the UE to reduce a number of times the UE transitions to an active state and enables the UE to extend a sleep state for a longer duration. For example, the network node may mitigate the UE waking up for two separate occasions (e.g., a first on-duration in which the UE transmits an SR and a second on-duration in which the UE receives an uplink grant). Reducing the number of times the UE transitions to an active state enabling the UE to extend a sleep state may also result in reduced power consumption and increased power savings at the UE, and the reduced power consumption and the increased power savings at the UE may extend an operating duration of the UE.

As indicated above, FIGS. 5A and 5B are provided as examples. Other examples may differ from what is described with regard to FIGS. 5A and 5B are.

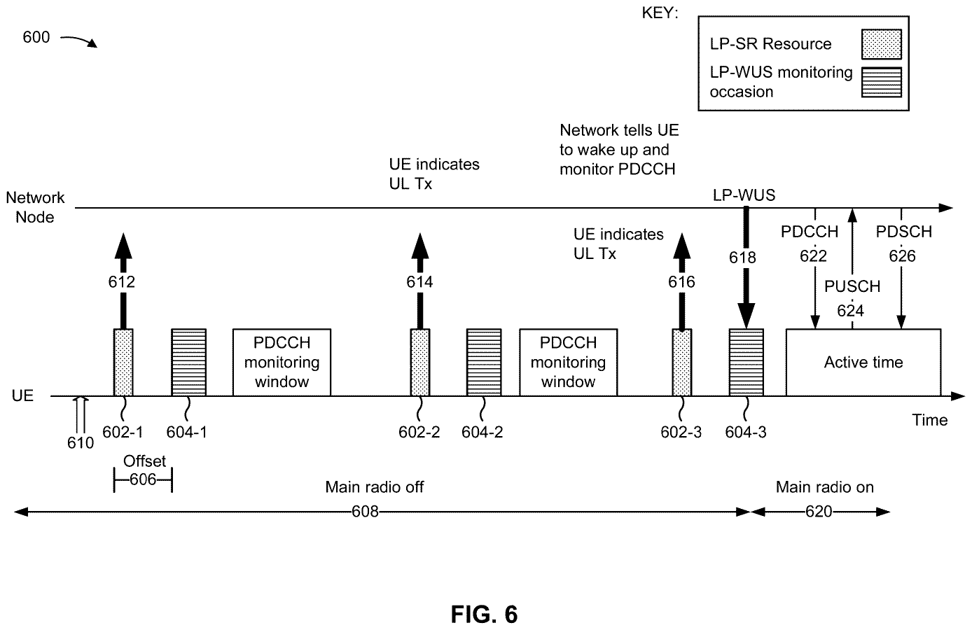

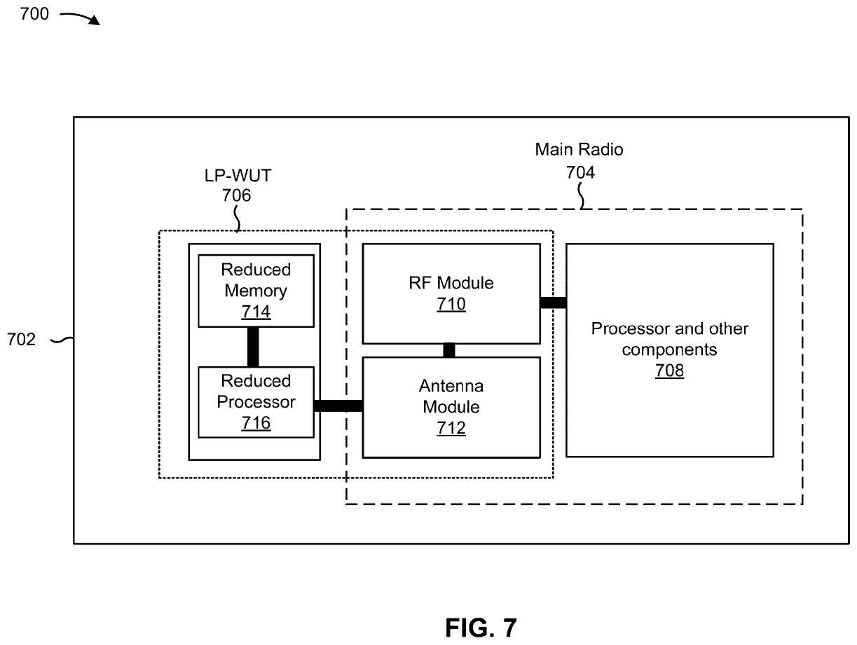

FIG. 6 is a diagram illustrating an example 600 of an LP-SR procedure.

A network node (e.g., a network node 110) may configure a UE (e.g., a UE 120) with one or more LP-SR resources that are dedicated or allocated to an LP-SR transmission by the UE. For example, each LP-SR resource may include one or more air interface resources that are characterized, at least in part, by a respective time partition and a respective frequency partition, and the air interface resource(s) of an LR-SR resource may be allocated to a respective LP-SR transmission. In some aspects, each LP-SR resource may be assigned to a standalone uplink signal that is not carried by an uplink channel (e.g., a PUCCH, a PUSCH, or a PRACH). As an example, the network node may transmit an indication of an LP-SR resource allocation that is assigned to the UE in DCI, one or more MAC-CEs, RRC signaling, or any combination thereof. In some cases, the network node may transmit the indication of the LP-SR resource allocation based at least in part on the UE operating in an active state, or prior to the UE operating in a C-DRX mode. For instance, the network node may transmit the indication as at least part of a DRX configuration.

In some aspects, one or more of the LP-SR resources in the LP-SR resource allocation have an association with one or more LP-WUS monitoring occasions. As one example, each respective LP-SR resource may be associated with a respective LP-WUS monitoring occasion. That is, the network node may configure a respective LP-SR for each LP-WUS monitoring occasion such that there is a one-to-one relationship between the LP-SR resources and the LP-WUS monitoring occasions or one-to-many relationship between the LP-SR resources and the LP-WUS monitoring occasions. Alternatively, or additionally, a location of an LP-SR resource may be based at least in part on an LP-WUS monitoring occasion. For instance, each LP-SR resource may be located before (e.g., in the time domain) the respective LP-WUS monitoring occasion. In some cases, each LP-SR resource may be located before the respective LP-WUS monitoring occasion by a time offset, such as a fixed time offset that is specified by a communication offset or a time offset that is configured by the network node. To illustrate, the network node may indicate a time offset in a DRX configuration, and the time offset may apply to all LP-SR resources in the LP-SR resource allocation such that each LP-SR resource occurs prior in time to the associated LP-WUS monitoring occasion by the time offset. Example time offsets (e.g., specified by a communication standard or configured by a network node) include a symbol offset (e.g., one symbol, two, symbols, or three symbols), a slot offset (e.g., one slot, two slot, or three slots), or a subframe offset (e.g., one subframe, two subframes, or three subframes).

To illustrate, the example 600 includes two time lines: a first timeline that is associated with a network node and a second timeline that is associated with a UE. The network node may configure the UE with one or more LP-SR resources, shown by FIG. 6 as LP-SR resource 602-1, LP-SR resource 602-2, and LP-SR resource 602-3 with a dotted pattern, and one or more LP-WUS monitoring occasions 604, shown by FIG. 6 as LP-WUS monitoring occasion 604-1, LP-WUS monitoring occasion 604-2, and LP-WUS monitoring occasion 604-3 with horizontal stripes. Each LP-SR resource may be associated with a respective LP-WUS monitoring occasion. In some cases, as shown by FIG. 6, a starting location of an LP-SR resource may be based at least in part on a starting location of the associated LP-WUS monitoring occasion (e.g., based at least in part on a time offset 606). The network node may configure the LP-SR resources and the LP-WUS monitoring occasions based at least in part on a C-DRX cycle of the UE such that the LP-SR resources and the LP-WUS monitoring occasions are located in time during a sleep state of the UE. Based at least in part on operating in a sleep state, the UE may have a main radio disabled or turned off as shown by reference number 608.

As shown by reference number 610, the UE may determine that uplink data is available for transmission. For instance, as described above, the UE may monitor a transmit buffer status, and the transmit buffer status may indicate that uplink data is available for transmission. Accordingly, the UE may transmit an LP-SR 612 using the LP-SR resource 602-1 to indicate that the UE has uplink data available to transmit. Alternatively, or additionally, the LP-SR 612 indicates a scheduling request from the UE. In some cases, the UE may transmit the LP-SR 612 using an LP-WUT, such as an LP-WUT described with regard to FIG. 3B and FIG. 7. The use of an LP-WUT may allow the UE to remain in a sleep state and may allow the UE keep the main radio in a disabled mode or an off mode and reduce energy consumption. In some cases, the LP-SR may carry one or more bits that are modulated using a less complex modulation format relative to OFDM, such as OOK, BPSK, or ASK, that may be transmitted by the LP-WUT using less power relative to the main radio. That is, the LP-SR may be configured such that the UE may transmit the LP-SR during a sleep state. As one example, the LP-SR may carry one bit, where a first value (e.g., “1”) indicates a scheduling request, and a second value (e.g., “0”) indicates no scheduling request. As another example, a presence of an LP-SR may indicate a scheduling request, and a lack of presence for the LP-SR may indicate no scheduling request.

In some aspects, the UE may receive an LP-WUS in an LP-WUS monitoring occasion that is associated with the LP-SR resource used to transmit the LP-SR. Based at least in part on receiving the LP-WUS, the UE may transition to an active state and monitor for PDCCH communication during an active time of the C-DRX cycle. That is, the UE may monitor for an uplink grant that is assigned to the UE. For example, the UE may monitor for PDCCH communication in a PDCCH monitoring window, or an on-duration, that is associated with the LP-WUS monitoring occasion used to receive the LP-WUS.

In other aspects, based at least in part on not receiving an LP-WUS in an LP-WUS monitoring occasion that is associated with the LP-SR resource used to transmit the LP-SR, the UE may remain in the sleep state. Alternatively, or additionally, the UE may keep the main radio in a disabled state or an off state. To illustrate, based at least in part on not receiving an LP-WUS in the LP-WUS monitoring occasion 604-1 (e.g., that is associated with the LP-SR resource 602-1), the UE may remain in the sleep state and the main radio in the off state as shown by reference number 608. The UE may iteratively transmit an LP-SR using a respective LP-SR resource. For example, as shown by FIG. 6, the UE may transmit an LP-SR 614 using the LP-SR resource 602-2 based at least in part on not receiving an LP-WUS in the LP-WUS monitoring occasion 604-1. Based at least in part on not receiving an LP-WUS in the LP-WUS monitoring occasion 604-2, the UE may remain in the sleep state and may keep the main radio in a disabled state or off state as shown by reference number 608. In a similar manner, based at least in part on not receiving an LP-WUS in the LP-WUS monitoring occasion 604-2, the UE may transmit an LP-SR 616 using the LP-SR resource 602-3.

As shown by FIG. 6, the network node may transmit an LP-WUS 618 in the LP-WUS monitoring occasion 604-3. Accordingly, the UE may transition to an active state that includes the UE enabling the main radio or turning the main radio to an on state as shown by reference number 620. Based at least in part on transitioning to the active state, the UE may monitor a PDCCH window that is associated with the LP-WUS monitoring occasion 604-3. The network node may transmit a PDCCH communication 622 within the PDCCH window, and the PDCCH communication 622 may carry an uplink grant that is assigned to the UE, a downlink grant that is assigned to the UE, or a combination of the two. For example, the PDCCH communication 622 may carry both a downlink grant and an uplink grant such that, during a single active time (e.g., an on-duration and an inactivity timer), the UE may transmit a PUSCH communication 624 using the uplink grant and may receive a PDSCH communication 626 using the downlink grant. Through the use of an LP-SR, by way of an LP-SR resource allocation, the UE may indicate, prior to a transition to an active state, a request for an uplink grant, such that the network node may coordinate a downlink grant and an uplink grant in a same active time, and reduce a number of times the UE transitions to an active state. For instance, with regard to the example 600, the network node may wait to transmit the LP-WUS 618, such as by skipping transmission of an LP-WUS in the LP-WUS monitoring occasion 604-1 and the LP-WUS monitoring occasion 604-2, until a time at which the network node has a downlink transmission for the UE. While the example 600 includes the network node transmitting the LP-WUS 618 based at least in part on receiving the LP-SR 616, other examples may include the network node transmitting an LP-WUS independent of, or without receiving, an LP-SR, such as in a first scenario in which the network node has downlink data to transmit (e.g., time sensitive downlink data) or a second scenario in which the network node transmits an uplink grant to the UE and a request for an uplink transmission from the UE.

In some aspects, the UE may transmit an SR using the main radio. To illustrate, the UE may be operating in a C-DRX mode as described above and may transition to an active time to monitor for PDCCH communication. As one example, the UE may receive an LP-WUS (e.g., without transmitting an LP-SR) that indicates to initiate monitoring for PDCCH communication. As another example, the UE may be configured to transition to an active state for each PDCCH monitoring window. Based at least in part on monitoring for PDCCH communication, the UE may transmit an SR within an active time. That is, the UE may transmit the SR regardless of a configured SR periodicity, a configured SR offset, or a combination of the two. To illustrate, based at least in part on the configured SR periodicity, the configured SR offset, or a combination of the two, transmission of an SR may be disallowed. However, the UE may transmit an SR outside of allowed times (e.g., as specified by the configured SR periodicity and the configured SR offset) based at least in part on operating in a C-DRX enabled mode and operating in an active state of a C-DRX cycle to mitigate multiple transitions to an active state and to leverage a current active state. In some aspects, the UE may transmit an SR based at least in part on determining that uplink data is ready for transmission. Alternatively, or additionally, the UE may transmit the SR based at least in part on failing to receive an LP-WUS after transmitting N LP-SRs using N LP-SR resources (N being an integer). To illustrate, the network node may configure the UE to transmit an SR after transmitting the N LP-SRs and failing to receive an uplink grant, failing to detect an LP-WUS, or a combination of the two. Accordingly, the UE may transmit an SR based at least in part on satisfying a failure threshold that is associated with transmitting one or more LP-WUSs without receiving an uplink grant. To illustrate, the UE may retransmit an LP-SR N times (N being an integer) based at least in part on failing to receive an LP-WUS in an LP-WUS monitoring occasion that is associated with the LP-SR resource used to transmit an initial LP-SR and based at least in part on failing to receive a respective LP-WUS for each retransmission of the LP-SR. That is, the UE may transmit the LP-SR N+1 times, and may fail to receive N+1 LP-WUSs such that a quantity of failures satisfies a failure threshold. Accordingly, the UE may transition to an active state based at least in part on satisfying the failure threshold and may transmit an SR using the main radio. As another example, the UE may activate a failure timer based at least in part on transmitting an initial LP-SR, and may continue to retransmit the LP-SR for a duration of the failure timer and based at least in part on failing to receive an LP-WUS prior to expiration of the failure timer. The UE may detect expiration of the failure timer, may transition to an active state, and may transmit an SR using the main radio.

A UE transmitting an LP-SR based at least in part on operating in a sleep state of a C-DRX mode may enable a network node to coordinate a downlink grant with an uplink grant in a same active time of the UE, and reduce a number of times the UE transitions to the active state. Alternatively, or additionally, the network node coordinating the downlink grant with the uplink grant may enable the UE to extend a sleep state for a longer duration. For example, the network node may mitigate the UE waking up for two separate occasions (e.g., a first on-duration in which the UE transmits an SR and a second on-duration in which the UE receives an uplink grant). Reducing the number of times the UE transitions to an active state enabling the UE to extend a sleep state may also result in reduced power consumption and increased power savings at the UE, and the reduced power consumption and the increased power savings at the UE may extend an operating duration at the UE.

As indicated above, FIG. 6 is provided as an example. Other examples may differ from what is described with regard to FIG. 6.

FIG. 7 is a diagram illustrating an example 700 of an LP-WUT.

The example 700 shown by FIG. 7 includes a transceiver module 702 that may be used for wireless communications. In the example 700, the transceiver module includes a main radio 704 (shown with a dashed line) and an LP-WUT 706 (shown with a dotted line), where the LP-WUT 706 may be a low power wakeup transmitter or a low power wakeup transceiver. Alternatively, or additionally, the main radio 704 may be the main radio 305, or may include the main radio 305, that is described with regard to FIG. 3A. The main radio 704 includes a processor and other components module 708 that may include any combination of examples described with regard to the processing system 140 of the UE 120. The processor and other components module 708 connects to an RF module 710, and the RF module 710 connects to an antenna system 712. The RF module 710 may be or include any combination of components of an RF chain as described with regard to FIG. 1, and the antenna system 712 may be or include any combination of components of an antenna array as described with regard to FIG. 1.

The LP-WUT 706 includes a reduced processor 714 that may have reduced power consumption, reduced processing power, or a combination of the two, relative to a processor of the main radio 704. Examples of reduced power consumption or reduced processing power may include any combination of a reduced clock speed, a lower operating voltage, a smaller RAM size, a reduced cache size, or fewer enabled cores. The LP-WUT 706 also includes reduced memory 716 that, relative to memory used by the main radio 704, may be configured with fewer active memory cells, a lower operating voltage, a narrower memory bus width, or a slower refresh cycle, to reduce power consumption. In some cases, the LP-WUT 706 may connect to the same RF module (e.g., the RF module 710) and the same antenna system (e.g., the antenna system 712) as the main radio 704. In other examples, the LP-WUT 706 may connect to a separate RF module, a separate antenna system, or a combination of the two, than the main radio 704 based at least in part to reduce power consumption.

As indicated above, FIG. 7 is provided as an example. Other examples may differ from what is described with regard to FIG. 7.

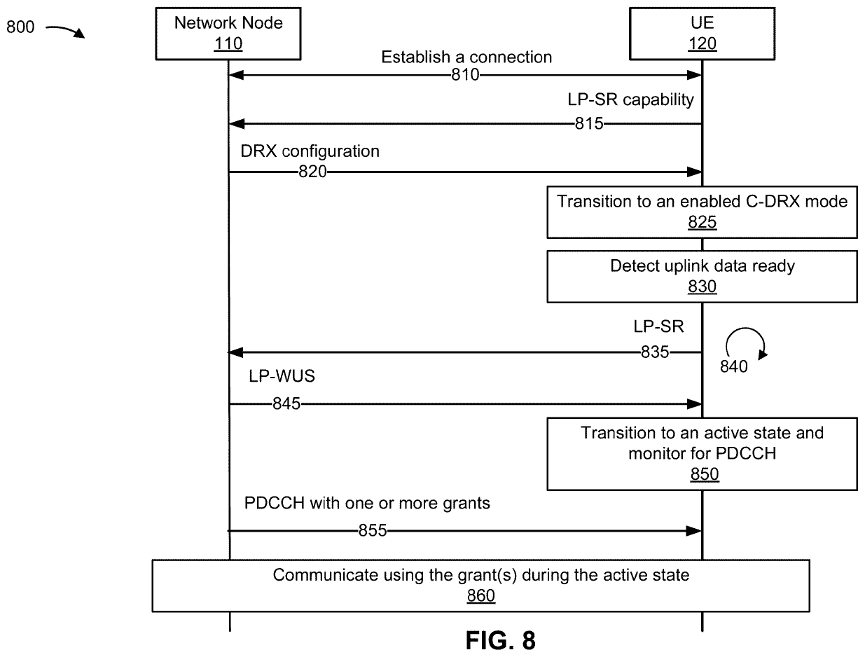

FIG. 8 is a diagram illustrating an example 800 of a wireless communication process between a network node 110 and a UE 120.

As shown by reference number 810, a network node 110 and a UE 120 may establish a connection. To illustrate, the UE 120 may power up in a cell coverage area provided by the network node 110, and the UE 120 and the network node 110 may perform one or more procedures (e.g., a random access channel (RACH) procedure, an RRC procedure, or a combination of the two) to establish a wireless connection. As another example, the UE 120 may move into the cell coverage area provided by the network node 110 and may perform a handover from a source network node (e.g., another network node 110) to the network node 110. Alternatively, or additionally, the network node 110 and the UE 120 may communicate via the connection based at least in part on any combination of Layer 1 signaling (e.g., DCI, UCI, or a combination), Layer 2 signaling (e.g., a MAC-CE), or Layer 3 signaling (e.g., RRC signaling). To illustrate, the network node 110 may request, via RRC signaling, UE capability information, and the UE 120 may transmit, via RRC signaling, the UE capability information. As part of communicating via the connection, the network node 110 may transmit configuration information via Layer 3 signaling (e.g., RRC signaling), and activate or deactivate a particular configuration via Layer 2 signaling (e.g., a MAC-CE), Layer 1 signaling (e.g., DCI), or a combination. To illustrate, the network node 110 may transmit the configuration information via Layer 3 signaling at a first point in time associated with the UE 120 being tolerant of communication delays, and the network node 110 may transmit an activation of the configuration via Layer 2 signaling, Layer 1 signaling, or a combination, at a second point in time associated with the UE being less tolerant to communication delays.

As shown by reference number 815, the UE 120 may transmit, and the network node 110 may receive, an indication of an LP-SR capability. To illustrate, the UE 120 may indicate support for an LP-WUT, support for transmitting an LP-SR, support for receiving and using an LP-SR resource allocation, or any combination thereof. For clarity, FIG. 8 illustrates the UE 120 transmitting the indication of the LP-SR capability in a separate transaction than establishing a connection with the network node 110. However, in some aspects, the UE 120 may transmit the indication of the LP-SR capability as part of establishing a connection with the network node 110.

As shown by reference number 820, the network node 110 may transmit, and the UE 120 may receive, a DRX configuration. As one example, the network node may transmit an indication of a DRX configuration that configures a C-DRX mode at the UE 120, such as a DRX configuration that indicates a configuration for any combination of a C-DRX cycle duration, an on-duration, a sleep state duration, an inactivity timer, a DCP state (e.g., enabled or disabled), an LP-WUS state (e.g., enabled or disabled), or an LP-SR state (e.g., enabled or disabled). In some aspects, the DRX configuration may indicate an LP-WUS monitoring occasion configuration that configures one or more LP-WUS monitoring occasions (e.g., LP-WUS monitoring occasions that are associated with the UE 120 operating in a sleep state). Based at least in part on the UE 120 indicating an LP-SR capability, the network node 110 may indicate, in the DRX configuration, an LP-SR resource allocation. However, the network node 110 may transmit an indication of an LP-SR resource allocation in a different transmission than a transmission that carries an indication of a DRX configuration in other examples.

Each LP-SR resource of the LP-SR resource allocation may include one or more air interface resources (e.g., resource elements (REs)) that are characterized at least in part by a respective time partition and a respective frequency partition. Alternatively, or additionally, each LP-SR resource may be associated with, or configured based at least in part on, a respective LP-WUS monitoring occasion. As an example, each LP-WUS monitoring occasion that is configured via the LP-WUS monitoring occasion configuration may have a companion or associated LP-SR resource, and a starting location of the companion LP-SR resource may be based at least in part on a starting location of the LP-WUS monitoring occasion (or vice versa). For instance, the DRX configuration may indicate an LP-SR offset that is a time offset from a starting location of an LP-WUS monitoring occasion, and the LP-SR offset may be used to derive a starting location of the associated LP-SR resource. In other examples, a communication standard may specify the time offset, or multiple potential time offsets, and the DRX configuration indicates selection of a particular potential time offset of the multiple potential time offsets. Accordingly, a respective location (e.g., time location) of each LP-SR resource in the LP-SR resource allocation may be associated with, or based at least in part on, on a respective location (e.g., time location) of a companion LP-WUS monitoring occasion. An LP-SR resource may be a companion to, and associated with, and an LP-WUS monitoring occasion that is a first LP-WUS monitoring occasion that occurs after the LP-SR resource.

As shown by reference number 825, the UE 120 may transition to an enabled C-DRX mode. For instance, the UE 120 may operate in a connected mode (e.g., RRC_CONNECTED mode) and may transition to an enabled C-DRX mode in which the UE 120 transitions between an active state and a sleep state as described with regard to FIGS. 4A, 4B, 5A, 5B, and 6. As at least part of transitioning to the sleep state, the UE 120 may disable a main radio or reduce an amount of power supplied to the main radio. Alternatively, or additionally, as at least part of transitioning to the sleep state, the UE 120 may monitor one or more LP-WUS monitoring occasions using an LP-WUR.

As shown by reference number 830, the UE 120 may detect that uplink data is ready for transmission. For example, the UE 120 may monitor a transmit buffer status, and the transmit buffer status may indicate that uplink data is ready for an uplink transmission.

As shown by reference number 835, the UE 120 may transmit, and the network node 110 may receive, an LP-SR. For instance, the UE 120 may transmit the LP-SR based at least in part on detecting that uplink data is ready for transmission. In some cases, the UE 120 may transmit the LP-SR using an LP-SR resource from the LP-SR resource allocation. Alternatively, or additionally, the UE 120 may transmit the LP-SR using an LP-WUT, such as the LP-WUT described with regard to FIG. 7.

As shown by reference number 840, the UE 120 may iteratively transmit an LP-SR. As one example, based at least in part on transmitting the LP-SR as described with regard to reference number 835, the UE may monitor an LP-WUS monitoring occasion (e.g., the companion LP-WUS monitoring occasion to the LP-SR resource used to transmit the LP-SR) for an LP-WUS. For instance, the UE 120 may monitor for an LP-WUS using an LP-WUR and not a main radio to reduce power consumption by the UE 120. In some aspects, the UE 120 may fail to receive an LP-WUS in the associated LP-WUS monitoring occasion, and may subsequently retransmit the LP-SR using another LP-SR resource in the LP-SR resource allocation. The UE 120 may iteratively retransmit the LP-SR multiple times based at least in part on failing to detect a respective LP-WUS for each LP-SR retransmission.

In some aspects, the UE 120 may be configured to cease retransmitting the LP-SR based at least in part on detecting a failure, such as a first failure that is associated with expiration of a failure timer or a second failure that is associated with a quantity of LP-SR transmissions (e.g., an initial LP-SR transmission and multiple LP-SR retransmissions) satisfying a failure threshold. For instance, the UE 120 may activate a failure timer based at least in part on transmitting an initial LP-SR as described with regard to reference number 835, and may detect a failure based at least in part on expiration of the failure timer and without detecting any LP-WUS transmission prior to expiration of the failure timer. As another example, the UE 120 may count LP-SR transmissions (e.g., an initial LP-SR transmission in combination with LP-SR retransmissions), and may detect a failure based at least in part on the count satisfying the failure threshold. In some cases, the DRX configuration may indicate a duration of the failure timer or may indicate a value for the failure threshold. As described below, the UE 120 may transition to the active state based at least in part on detecting the failure.

While the example 800 includes an example of the UE 120 iteratively transmitting an LP-SR multiple times, other examples may include the UE 120 transmitting a single LP-SR or the UE 120 not transmitting an LP-SR. As an example, the UE 120 may transmit a single LP-SR and may detect an LP-WUS in the associated LP-WUS monitoring occasion. As another example, the UE 120 may not transmit an LP-SR based at least in part on not detecting that uplink data is ready for transmission.

As shown by reference number 845, the network node 110 may transmit, and the UE 120 may receive, an LP-WUS. To illustrate, the network node 110 may transmit the LP-WUS in an associated LP-WUS monitoring occasion of at least one LP-SR received by the network node 110. For instance, as described with regard to FIG. 6, the network node 110 may delay transmission of the LP-WUS to a point in time when the network node 110 may coordinate a downlink grant and an uplink grant in a same on-duration of a C-DRX cycle.

While the network node 110 may transmit the LP-WUS based at least in part on receiving an LP-SR, other examples may include the network node 110 transmitting an LP-WUS without receiving an LP-SR from the UE 120. For instance, the network node 110 may transmit the LP-WUS based at least in part on having a downlink communication to transmit to the UE 120, or based at least in part on having an uplink communication request for the UE 120.

As shown by reference number 850, the UE 120 may transition to an active state and may monitor for PDCCH communication based at least in part on receiving an LP-WUS. In some aspects, the UE 120 may monitor for an uplink grant indication via the PDCCH, such as in a scenario in which the UE 120 has transmitted an LP-SR. While the example 800 includes the UE 120 transitioning to the active state based at least in part on receiving the LP-WUS, other examples may include the UE 120 transitioning to the active state based at least in part on having a pending SR to transmit as described below.

As shown by reference number 855, the network node 110 may transmit, and the UE 120 may receive a PDCCH communication, and the PDCCH communication may indicate one or more grants that are allocated to the UE 120. To illustrate, the PDCCH communication may carry an uplink grant indication that is directed to the UE 120, a downlink grant indication that is directed to the UE 120, or a combination of the two.

As shown by reference number 860, the network node 110 and the UE 120 may communicate with one another using the grant(s) indicated in the PDCCH communication. As one example, the UE 120 may transmit, and the network node 110 may receive, an uplink communication using an uplink grant that is specified by the uplink grant indication carried in the PDCCH communication. Alternatively, or additionally, the network node 110 may transmit, and the UE 120 may receive, a downlink communication using a downlink grant that is specified by the downlink grant indication.

As described above, the UE 120 may transmit an SR based at least in part on operating in the active state (e.g., during the on-duration associated with the active state). As described with regard to reference number 850, the UE 120 may transition to the active state based at least in part on receiving an LP-WUS. In other cases, the UE 120 may transition to the active state based at least in part on detecting a failure, such as a first failure based at least in part on detecting expiration of a failure timer or a second failure that is associated with a quantity of LP-SR transmissions satisfying a failure threshold. The first failure and the second failure may also be based at least in part on the UE 120 failing to receive an LP-WUS (e.g., prior to expiration of the failure timer or as a response to any of the multiple LP-SR transmissions). Accordingly, the UE 120 may transition to the active state without receiving an LP-WUS and may transmit an SR. Alternatively, the UE 120 may transmission to the active state based at least in part on receiving an LP-WUS (e.g., associated with a pending downlink grant) and may transmit the SR based at least in part on detecting a failure and transitioning to the active state.

Alternatively, or additionally, the UE 120 may detect, based at least in part on receiving an LP-WUS (e.g., associated with a pending a downlink grant) and transitioning to the active state, that uplink data is ready for an uplink transmission. That is, the UE 120 may receive an LP-WUS from the network node 110 without transmitting an LP-SR as described above and may detect that uplink data is ready while operating in the active state. Accordingly, the UE may transmit an SR for an uplink grant (and without using the LP-SR resource allocation to transit an LP-SR) to leverage being in the active state and to reduce power consumption by the UE.

A UE transmitting an LP-SR based at least in part on operating in a sleep state of a C-DRX mode may enable a network node to coordinate a downlink grant with an uplink grant in a same active time of the UE, and to reduce a number of times the UE transitions to the active state. Alternatively, or additionally, the network node coordinating the downlink grant with the uplink grant may enable the UE to extend a sleep state for a longer duration. For example, the network node may mitigate the UE waking up for two separate occasions (e.g., a first on-duration in which the UE transmits an SR and a second on-duration in which the UE receives an uplink grant). Reducing the number of times the UE transitions to an active state enabling the UE to extend a sleep state may also result in reduced power consumption and increased power savings at the UE, and the reduced power consumption and the increased power savings at the UE may extend an operating duration at the UE.

As indicated above, FIG. 8 is provided as an example. Other examples may differ from what is described with regard to FIG. 8.

FIG. 9 is a diagram illustrating an example process 900 performed, for example, at a UE or an apparatus of a UE. Example process 900 is an example where the apparatus or the UE (e.g., UE 120) performs operations associated with an LP-SR.

As shown in FIG. 9, in some aspects, process 900 may include receiving, based at least in part on being in an active state, an LP-SR resource allocation (block 910). For example, the UE (e.g., using reception component 1302 or communication manager 1306, depicted in FIG. 13) may receive, based at least in part on being in an active state, an LP-SR resource allocation, as described above.

As further shown in FIG. 9, in some aspects, process 900 may include transitioning to a sleep state (block 920). For example, the UE (e.g., using communication manager 1306, depicted in FIG. 13) may transition to a sleep state, as described above.

As further shown in FIG. 9, in some aspects, process 900 may include transmitting an LP-SR using an LP-SR resource in the LP-SR resource allocation (block 930). For example, the UE (e.g., using transmission component 1304 or communication manager 1306, depicted in FIG. 13) may transmit an LP-SR using an LP-SR resource in the LP-SR resource allocation, as described above.

Process 900 may include additional aspects, such as any single aspect or any combination of aspects described below or in connection with one or more other processes described elsewhere herein.

In a first aspect, each LP-SR resource in the LP-SR resource allocation is associated with a respective LP-WUS monitoring occasion.

In a second aspect, a first respective location of each LP-SR resource in the LP-SR resource allocation is associated with a second respective location of a respective LP-WUS monitoring occasion.

In a third aspect, process 900 includes obtaining an indication that uplink data is ready for an uplink transmission, and transmitting the LP-SR using the LP-SR resource is based at least in part on obtaining the indication that the uplink data is ready for the uplink transmission.

In a fourth aspect, process 900 includes monitoring an LP-WUS monitoring occasion for an LP-WUS, the LP-WUS monitoring occasion being associated with the LP-SR resource.

In a fifth aspect, process 900 includes receiving, based at least in part on transmitting the LP-SR, an LP-WUS, and monitoring, based at least in part on receiving the LP-WUS, for an uplink grant indication.

In a sixth aspect, monitoring for the uplink grant indication includes monitoring for a PDCCH in a PDCCH window that is based at least in part on the LP-WUS.

In a seventh aspect, process 900 includes receiving a PDCCH, and the PDCCH carries the uplink grant indication.

In an eighth aspect, process 900 includes transmitting an uplink communication using an uplink grant that is specified by the uplink grant indication.

In a ninth aspect, process 900 includes receiving a PDCCH that carries the uplink grant indication and a downlink grant indication, transmitting, during an active time of the UE, an uplink communication using an uplink grant that is specified by the uplink grant indication, and receiving, during the active time used to transmit the uplink communication, a downlink communication using a downlink grant that is specified by the downlink grant indication.

In a tenth aspect, the LP-SR resource is a first LP-SR resource in the LP-SR resource allocation, and process 900 includes failing to receive an LP-WUS in an LP-WUS monitoring occasion that is associated with the first LP-SR resource, and retransmitting the LP-SR using a second LP-SR resource in the LP-SR resource allocation.

In an eleventh aspect, the LP-SR further including failing to receive an LP-WUS in an LP-WUS monitoring occasion that is associated with the LP-SR resource, retransmitting the LP-SR N times based at least in part on a failure to receive a respective LP-WUS for each retransmission of the LP-SR, N being an integer, transitioning to an active state based at least in part on the failure, and transmitting an SR based at least in part on the failure.

In a twelfth aspect, process 900 includes activating a failure timer based at least in part on transmitting the LP-SR, failing to receive an LP-WUS prior to expiration of the failure timer, detecting expiration of the failure timer, a transitioning to an active state based at least in part on the expiration of the failure timer, and transmitting an SR based at least in part on the expiration of the failure timer.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, at a UE or an apparatus of a UE. Example process 1000 is an example where the apparatus or the UE (e.g., UE 120) performs operations associated with an LP-SR.

As shown in FIG. 10, in some aspects, process 1000 may include receiving, based at least in part on being in an active state, an LP-SR resource allocation (block 1010). For example, the UE (e.g., using reception component 1302 or communication manager 1306, depicted in FIG. 13) may receive, based at least in part on being in an active state, an LP-SR resource allocation, as described above.

As further shown in FIG. 10, in some aspects, process 1000 may include transitioning to a sleep state (block 1020). For example, the UE (e.g., using communication manager 1306, depicted in FIG. 13) may transition to a sleep state, as described above.

As further shown in FIG. 10, in some aspects, process 1000 may include receiving an LP-WUS without transmitting an LP-SR (block 1030). For example, the UE (e.g., using reception component 1302 or communication manager 1306, depicted in FIG. 13) may receive an LP-WUS without transmitting an LP-SR, as described above.

As further shown in FIG. 10, in some aspects, process 1000 may include transitioning to an active state based at least in part on receiving the LP-WUS (block 1040). For example, the UE (e.g., using communication manager 1306, depicted in FIG. 13) may transition to an active state based at least in part on receiving the LP-WUS, as described above.

As further shown in FIG. 10, in some aspects, process 1000 may include obtaining an uplink data ready indication for an uplink transmission (block 1050). For example, the UE (e.g., using reception component 1302 or communication manager 1306, depicted in FIG. 13) may obtain an uplink data ready indication for an uplink transmission, as described above.

As further shown in FIG. 10, in some aspects, process 1000 may include transmitting, based at least in part on operating in the active state, an SR for an uplink grant based at least in part on receiving the uplink data ready indication and without using the LP-SR resource allocation (block 1060). For example, the UE (e.g., using transmission component 1304 or communication manager 1306, depicted in FIG. 13) may transmit, based at least in part on operating in the active state, an SR for an uplink grant based at least in part on receiving the uplink data ready indication and without using the LP-SR resource allocation, as described above.

Process 1000 may include additional aspects, such as any single aspect or any combination of aspects described below or in connection with one or more other processes described elsewhere herein.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, at a network node or an apparatus of a network node. Example process 1100 is an example where the apparatus or the network node (e.g., network node 110) performs operations associated with an LP-SR.

As shown in FIG. 11, in some aspects, process 1100 may include transmitting an LP-SR resource allocation that is assigned to a UE and is associated with the UE operating in a sleep state (block 1110). For example, the network node (e.g., using transmission component 1404 or communication manager 1406, depicted in FIG. 14) may transmit an LP-SR resource allocation that is assigned to a UE and is associated with the UE operating in a sleep state, as described above.

As further shown in FIG. 11, in some aspects, process 1100 may include receiving an LP-SR in an LP-SR resource in the LP-SR resource allocation (block 1120). For example, the network node (e.g., using reception component 1402 or communication manager 1406, depicted in FIG. 14) may receive an LP-SR in an LP-SR resource in the LP-SR resource allocation, as described above.

Process 1100 may include additional aspects, such as any single aspect or any combination of aspects described below or in connection with one or more other processes described elsewhere herein.

In a first aspect, each LP-SR resource in the LP-SR resource allocation is associated with a respective LP-WUS monitoring occasion, and process 1100 includes transmitting an LP-WUS in the respective LP-WUS monitoring occasion that is associated with the LP-SR.

In a second aspect, process 1100 includes transmitting, based at least in part on an on-duration of an active state, an uplink grant indication that is directed to the UE.

In a third aspect, transmitting the uplink grant indication includes transmitting a PDCCH that carries the uplink grant indication in a PDCCH window that is based at least in part on the LP-WUS.

In a fourth aspect, process 1100 includes receiving an uplink communication using an uplink grant that is specified by the uplink grant indication.

In a fifth aspect, process 1100 includes transmitting a PDCCH that carries an uplink grant indication and a downlink grant indication, transmitting, during an active time of the UE, a downlink communication using a downlink grant that is specified by the downlink grant indication, and receiving, during the on-duration, an uplink transmission using an uplink grant that is specified by the uplink grant indication.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, at a network node or an apparatus of a network node. Example process 1200 is an example where the apparatus or the network node (e.g., network node 110) performs operations associated with an LP-SR.

As shown in FIG. 12, in some aspects, process 1200 may include transmitting an LP-SR resource allocation that is directed to a UE operating in an active state (block 1210). For example, the network node (e.g., using transmission component 1404 or communication manager 1406, depicted in FIG. 14) may transmit an LP-SR resource allocation that is directed to a UE operating in an active state, as described above.

As further shown in FIG. 12, in some aspects, process 1200 may include transmitting, based at least in part on the UE operating in a sleep state and without receiving an LP-SR, an LP-WUS that instructs the UE to transition to an active state (block 1220). For example, the network node (e.g., using transmission component 1404 or communication manager 1406, depicted in FIG. 14) may transmit, based at least in part on the UE operating in a sleep state and without receiving an LP-SR, an LP-WUS that instructs the UE to transition to an active state, as described above.

As further shown in FIG. 12, in some aspects, process 1200 may include receiving, during an active time of the UE, and without using the LP-SR resource allocation, an SR for an uplink grant, the SR being associated with the UE (block 1230). For example, the network node (e.g., using reception component 1402 or communication manager 1406, depicted in FIG. 14) may receive, during an active time of the UE, and without using the LP-SR resource allocation, an SR for an uplink grant, the SR being associated with the UE, as described above.

Process 1200 may include additional aspects, such as any single aspect or any combination of aspects described below or in connection with one or more other processes described elsewhere herein.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram of an example apparatus 1300 for wireless communication. The apparatus 1300 may be a UE, or a UE may include the apparatus 1300. In some aspects, the apparatus 1300 includes a reception component 1302, a transmission component 1304, or a communication manager 1306, which may be in communication with one another (for example, via one or more buses or one or more other components). In some aspects, the communication manager 1306 is the communication manager 150 described in connection with FIG. 1. As shown, the apparatus 1300 may communicate with another apparatus 1308, such as a UE or a network node (such as a CU, a DU, an RU, or a base station), using the reception component 1302 and the transmission component 1304. The communication manager 1306 may be included in, or implemented via, a processing system (for example, the processing system 140 described in connection with FIG. 1) of the UE.

In some aspects, the apparatus 1300 may be configured to perform one or more operations described herein in connection with FIGS. 5-8. Additionally, or alternatively, the apparatus 1300 may be configured to perform one or more processes described herein, such as process 900 of FIG. 9, process 1000 of FIG. 10, or a combination thereof. In some aspects, the apparatus 1300 or one or more components shown in FIG. 13 may include one or more components of the UE described in connection with FIG. 1. Additionally, or alternatively, one or more components shown in FIG. 13 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1302 may receive communications, such as reference signals, control information, data communications, or a combination thereof, from the apparatus 1308. The reception component 1302 may provide received communications to one or more other components of the apparatus 1300. In some aspects, the reception component 1302 may perform signal processing on the received communications, and may provide the processed signals to the one or more other components of the apparatus 1300. In some aspects, the reception component 1302 may include one or more components of the UE described above in connection with FIG. 1, such as a radio, one or more RF chains, one or more transceivers, or one or more modems, each of which may in turn be coupled with one or more antennas of the UE.

The transmission component 1304 may transmit communications, such as reference signals, control information, data communications, or a combination thereof, to the apparatus 1308. In some aspects, one or more other components of the apparatus 1300 may generate communications and may provide the generated communications to the transmission component 1304 for transmission to the apparatus 1308. In some aspects, the transmission component 1304 may perform signal processing on the generated communications, and may transmit the processed signals to the apparatus 1308. In some aspects, the transmission component 1304 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 1304 may be co-located with the reception component 1302.

The communication manager 1306 may support operations of the reception component 1302 or the transmission component 1304. For example, the communication manager 1306 may receive information associated with configuring reception of communications by the reception component 1302 or transmission of communications by the transmission component 1304. Additionally, or alternatively, the communication manager 1306 may generate or provide control information to the reception component 1302 or the transmission component 1304 to control reception or transmission of communications.

The reception component 1302 may receive, based at least in part on being in an active state, an LP-SR resource allocation. The communication manager 1306 may transition to a sleep state. The transmission component 1304 may transmit an LP-SR using an LP-SR resource in the LP-SR resource allocation. Alternatively, or additionally, the communication manager 1306 may obtain an indication that uplink data is ready for an uplink transmission, and the transmission component 1304 may transmit the LP-SR using the LP-SR resource is based at least in part on obtaining the indication that uplink data ready for an uplink transmission.

The communication manager 1306 may monitor an LP-WUS monitoring occasion for an LP-WUS, the LP-WUS monitoring occasion being associated with the LP-SR resource. The reception component 1302 may receive, based at least in part on transmitting the LP-SR, an LP-WUS. In some cases, the communication manager 1306 may monitor, based at least in part on receiving the LP-WUS, for an uplink grant indication.

The reception component 1302 may receive a PDCCH, and the PDCCH carries the uplink grant indication. The transmission component 1304 may transmit an uplink communication using an uplink grant that is specified by the uplink grant indication. In some aspects, the reception component 1302 may receive a PDCCH that carries the uplink grant indication and a downlink grant indication.

The transmission component 1304 may transmit, during an active time, an uplink communication using an uplink grant that is specified by the uplink grant indication. The reception component 1302 may receive, during the active time used transmit the uplink communication, a downlink communication using a downlink grant that is specified by the downlink grant indication.

The communication manager 1306 may activate a failure timer based at least in part on transmitting the LP-SR. In some aspects, the communication manager 1306 may fail to receive an LP-WUS prior to expiration of the failure timer. The communication manager 1306 may detect expiration of the failure timer. Alternatively, or additionally, the communication manager 1306 may transition to an active state based at least in part on the expiration of the failure timer transmitting an SR based at least in part on the expiration of the failure timer.

The reception component 1302 may receive, based at least in part on being in an active state, an LP-SR resource allocation. The communication manager 1306 may transition to a sleep state. The reception component 1302 may receive an LP-WUS without transmitting an LP-SR. The communication manager 1306 may transition to an active state based at least in part on receiving the LP-WUS. The reception component 1302 may obtain an uplink data ready indication for an uplink transmission. The transmission component 1304 may transmit, based at least in part on operating in the active state, an SR for an uplink grant based at least in part on receiving the uplink data ready indication and without using the LP-SR resource allocation.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

FIG. 14 is a diagram of an example apparatus 1400 for wireless communication. The apparatus 1400 may be a network node, or a network node may include the apparatus 1400. In some aspects, the apparatus 1400 includes a reception component 1402, a transmission component 1404, or a communication manager 1406, which may be in communication with one another (for example, via one or more buses or one or more other components). In some aspects, the communication manager 1406 is the communication manager 155 described in connection with FIG. 1. As shown, the apparatus 1400 may communicate with another apparatus 1408, such as a UE or a network node (such as a CU, a DU, an RU, or a base station), using the reception component 1402 and the transmission component 1404. The communication manager 1406 may be included in, or implemented via, a processing system (for example, the processing system 145 described in connection with FIG. 1) of the network node.

In some aspects, the apparatus 1400 may be configured to perform one or more operations described herein in connection with FIGS. 5-8. Additionally, or alternatively, the apparatus 1400 may be configured to perform one or more processes described herein, such as process 1100 of FIG. 11, process 1200 of FIG. 12, or a combination thereof. In some aspects, the apparatus 1400 or one or more components shown in FIG. 14 may include one or more components of the network node described in connection with FIG. 1. Additionally, or alternatively, one or more components shown in FIG. 14 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1402 may receive communications, such as reference signals, control information, data communications, or a combination thereof, from the apparatus 1408. The reception component 1402 may provide received communications to one or more other components of the apparatus 1400. In some aspects, the reception component 1402 may perform signal processing on the received communications, and may provide the processed signals to the one or more other components of the apparatus 1400. In some aspects, the reception component 1402 may include one or more components of the network node described above in connection with FIG. 1, such as a radio, one or more RF chains, one or more transceivers, or one or more modems, each of which may in turn be coupled with one or more antennas of the network node. In some aspects, the reception component 1402 or the transmission component 1404 may include or may be included in a network interface. The network interface may be configured to obtain or output signals for the apparatus 1400 via one or more communications links, such as a backhaul link, a midhaul link, or a fronthaul link.

The transmission component 1404 may transmit communications, such as reference signals, control information, data communications, or a combination thereof, to the apparatus 1408. In some aspects, one or more other components of the apparatus 1400 may generate communications and may provide the generated communications to the transmission component 1404 for transmission to the apparatus 1408. In some aspects, the transmission component 1404 may perform signal processing on the generated communications, and may transmit the processed signals to the apparatus 1408. In some aspects, the transmission component 1404 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 1404 may be co-located with the reception component 1402.

The communication manager 1406 may support operations of the reception component 1402 or the transmission component 1404. For example, the communication manager 1406 may receive information associated with configuring reception of communications by the reception component 1402 or transmission of communications by the transmission component 1404. Additionally, or alternatively, the communication manager 1406 may generate or provide control information to the reception component 1402 or the transmission component 1404 to control reception or transmission of communications.

The transmission component 1404 may transmit an LP-SR resource allocation that is assigned to a UE and is associated with the UE operating in a sleep state. The reception component 1402 may receive an LP-SR in an LP-SR resource in the LP-SR resource allocation.

The transmission component 1404 may transmit, based at least in part on an active time of the UE, an uplink grant indication that is directed to the UE. In some aspects, the reception component 1402 may receive an uplink communication using an uplink grant that is specified by the uplink grant indication.

The transmission component 1404 may transmit a PDCCH that carries an uplink grant indication and a downlink grant indication. Alternatively, or additionally, the transmission component 1404 may transmit, during an active time of the UE, a downlink communication using a downlink grant that is specified by the downlink grant indication. The reception component 1402 may receive, during the active time, an uplink transmission using an uplink grant that is specified by the uplink grant indication.

The transmission component 1404 may transmit an LP-SR resource allocation that is directed to a UE operating in an active state. The transmission component 1404 may transmit, based at least in part on the UE operating in a sleep state and without receiving an LP-SR, an LP-WUS that instructs the UE to transition to an active state. The reception component 1402 may receive, during an active time of the UE, and without using the LP-SR resource allocation, an SR for an uplink grant, the SR being associated with the UE.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

The following provides an overview of some Aspects of the present disclosure:

Aspect 1: A method of wireless communication performed by a user equipment (UE), comprising: receiving, based at least in part on being in an active state, a low power scheduling request (LP-SR) resource allocation; transitioning to a sleep state; and transmitting an LP-SR using an LP-SR resource in the LP-SR resource allocation.

Aspect 2: The method of Aspect 1, wherein each LP-SR resource in the LP-SR resource allocation is associated with a respective low power wakeup signal (LP-WUS) monitoring occasion.

Aspect 3: The method of any of Aspects 1-2, wherein a first respective location of each LP-SR resource in the LP-SR resource allocation is associated with a second respective location of a respective low power wakeup signal (LP-WUS) monitoring occasion.

Aspect 4: The method of any of Aspects 1-3, further comprising: obtaining an indication that an uplink data is ready for an uplink transmission, wherein transmitting the LP-SR using the LP-SR resource is based at least in part on obtaining the indication that the uplink data is ready.

Aspect 5: The method of Aspect 4, further comprising: monitoring a low power wakeup signal (LP-WUS) monitoring occasion for an LP-WUS, the LP-WUS monitoring occasion being associated with the LP-SR resource.

Aspect 6: The method of any of Aspects 1-5, further comprising: receiving, based at least in part on transmitting the LP-SR, a low power wakeup signal (LP-WUS); and monitoring, based at least in part on receiving the LP-WUS, for an uplink grant indication.

Aspect 7: The method of Aspect 6, wherein monitoring for the uplink grant indication comprises: monitoring for a physical downlink control channel (PDCCH) in a PDCCH window that is based at least in part on the LP-WUS.

Aspect 8: The method of Aspect 6, further comprising: receiving a physical downlink control channel (PDCCH), wherein the PDCCH carries the uplink grant indication.

Aspect 9: The method of Aspect 8, further comprising: transmitting an uplink communication using an uplink grant that is specified by the uplink grant indication.

Aspect 10: The method of Aspect 6, further comprising: receiving a physical downlink control channel (PDCCH) that carries the uplink grant indication and a downlink grant indication; transmitting, during an active time of the UE, an uplink communication using an uplink grant that is specified by the uplink grant indication; and receiving, during the active time used to transmit the uplink communication, a downlink communication using a downlink grant that is specified by the downlink grant indication.

Aspect 11: The method of any of Aspects 1-10, wherein the LP-SR resource is a first LP-SR resource in the LP-SR resource allocation, and wherein the method further comprises: failing to receive a low power wakeup signal (LP-WUS) in an LP-WUS monitoring occasion that is associated with the first LP-SR resource; and retransmitting the LP-SR using a second LP-SR resource in the LP-SR resource allocation.

Aspect 12: The method of any of Aspects 1-11, wherein the LP-SR further comprising: failing to receive an LP-WUS in an LP-WUS monitoring occasion that is associated with the LP-SR resource; retransmitting the LP-SR N times based at least in part on a failure to receive a respective LP-WUS for each retransmission of the LP-SR, N being an integer; transitioning to an active state based at least in part on the failure; and transmitting a scheduling request (SR) based at least in part on the failure.

Aspect 13: The method of any of Aspects 1-12, further comprising: activating a failure timer based at least in part on transmitting the LP-SR; failing to receive an LP-WUS prior to expiration of the failure timer; detecting expiration of the failure timer; transitioning to an active state based at least in part on the expiration of the failure timer; and transmitting a scheduling request (SR) based at least in part on the expiration of the failure timer.

Aspect 14: A method of wireless communication performed by a user equipment (UE), comprising: receiving, based at least in part on being in an active state, a low power scheduling request (LP-SR) resource allocation; transitioning to a sleep state; receiving a low power wakeup signal (LP-WUS) without transmitting an LP-SR; transitioning to an active state based at least in part on receiving the LP-WUS; obtaining an uplink data ready indication for an uplink transmission; and transmitting, based at least in part on operating in the active state, a scheduling request (SR) for an uplink grant based at least in part on receiving the uplink data ready indication and without using the LP-SR resource allocation.

Aspect 15: A method of wireless communication performed by a network node, comprising: transmitting a low power scheduling request (LP-SR) resource allocation that is assigned to a user equipment (UE) and is associated with the UE operating in a sleep state; and receiving an LP-SR in an LP-SR resource in the LP-SR resource allocation.

Aspect 16: The method of Aspect 15, wherein each LP-SR resource in the LP-SR resource allocation is associated with a respective low power wakeup signal (LP-WUS) monitoring occasion, and wherein the method further comprises: transmitting an LP-WUS in the respective LP-WUS monitoring occasion that is associated with the LP-SR.

Aspect 17: The method of Aspect 16, further comprising: transmitting, based at least in part on an on-duration of an active state, an uplink grant indication that is directed to the UE.

Aspect 18: The method of Aspect 17, wherein transmitting the uplink grant indication comprises: transmitting a physical downlink control channel (PDCCH) that carries the uplink grant indication in a PDCCH window that is based at least in part on the LP-WUS.

Aspect 19: The method of Aspect 18, further comprising: receiving an uplink communication using an uplink grant that is specified by the uplink grant indication.

Aspect 20: The method of Aspect 16, further comprising, transmitting a physical downlink control channel (PDCCH) that carries an uplink grant indication and a downlink grant indication; transmitting, during an active time of the UE, a downlink communication using a downlink grant that is specified by the downlink grant indication; and receiving, during the on-duration, an uplink transmission using an uplink grant that is specified by the uplink grant indication.

Aspect 21: A method of wireless communication performed by a network node, comprising: transmitting a low power scheduling request (LP-SR) resource allocation that is directed to a user equipment (UE) operating in an active state; transmitting, based at least in part on the UE operating in a sleep state and without receiving a low power scheduling request (LP-SR), a low power wakeup signal (LP-WUS) that instructs the UE to transition to an active state; and receiving, during active time of the UE, and without using the LP-SR resource allocation, a scheduling request (SR) for an uplink grant, the SR being associated with the UE.

Aspect 22: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-14.

Aspect 23: An apparatus for wireless communication at a device, the apparatus comprising one or more memories and one or more processors coupled to the one or more memories, the one or more processors configured to cause the device to perform the method of one or more of Aspects 1-14.

Aspect 24: An apparatus for wireless communication, the apparatus comprising at least one means for performing the method of one or more of Aspects 1-14.

Aspect 25: A non-transitory computer-readable medium storing code for wireless communication, the code comprising instructions executable by one or more processors to perform the method of one or more of Aspects 1-14.

Aspect 26: A non-transitory computer-readable medium storing a set of instructions for wireless communication, the set of instructions comprising one or more instructions that, when executed by one or more processors of a device, cause the device to perform the method of one or more of Aspects 1-14.

Aspect 27: A device for wireless communication, the device comprising a processing system that includes one or more processors and one or more memories coupled with the one or more processors, the processing system configured to cause the device to perform the method of one or more of Aspects 1-14.

Aspect 28: An apparatus for wireless communication at a device, the apparatus comprising one or more memories and one or more processors coupled to the one or more memories, the one or more processors individually or collectively configured to cause the device to perform the method of one or more of Aspects 1-14.

Aspect 29: A device comprising a processing system that includes one or more processors and one or more code-storing memories coupled with the one or more processors, the processing system configured to cause the device to perform the method of one or more of Aspects 1-14.

Aspect 30: A device comprising a processing system that includes processor circuitry and code-storing memory circuitry, the processing system configured to cause the device to perform the method of one or more of Aspects 1-14.

Aspect 31: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 15-21.

Aspect 32: An apparatus for wireless communication at a device, the apparatus comprising one or more memories and one or more processors coupled to the one or more memories, the one or more processors configured to cause the device to perform the method of one or more of Aspects 15-21.

Aspect 33: An apparatus for wireless communication, the apparatus comprising at least one means for performing the method of one or more of Aspects 15-21.

Aspect 34: A non-transitory computer-readable medium storing code for wireless communication, the code comprising instructions executable by one or more processors to perform the method of one or more of Aspects 15-21.

Aspect 35: A non-transitory computer-readable medium storing a set of instructions for wireless communication, the set of instructions comprising one or more instructions that, when executed by one or more processors of a device, cause the device to perform the method of one or more of Aspects 15-21.

Aspect 36: A device for wireless communication, the device comprising a processing system that includes one or more processors and one or more memories coupled with the one or more processors, the processing system configured to cause the device to perform the method of one or more of Aspects 15-21.

Aspect 37: An apparatus for wireless communication at a device, the apparatus comprising one or more memories and one or more processors coupled to the one or more memories, the one or more processors individually or collectively configured to cause the device to perform the method of one or more of Aspects 15-21.

Aspect 38: A device comprising a processing system that includes one or more processors and one or more code-storing memories coupled with the one or more processors, the processing system configured to cause the device to perform the method of one or more of Aspects 15-21.

Aspect 39: A device comprising a processing system that includes processor circuitry and code-storing memory circuitry, the processing system configured to cause the device to perform the method of one or more of Aspects 15-21.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples. In various examples, the phrase “associated with” may be interpreted to mean “in association with,” “in accordance with,” “based on,” “based at least in part on,” “as a function of,” “in response to,” “responsive to,” or “using” as appropriate in the relevant context unless otherwise explicitly indicated. Furthermore, what follows the phrase “associated with,” “in association with,” “in accordance with,” “based on,” “based at least in part on,” “as a function of,” “in response to,” “responsive to,” or “using” is not necessarily the focal point or primary factor associated with the limitation preceding the phrase.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE), comprising:
a processing system that includes one or more processors and one or more code-storing memories coupled with the one or more processors, the processing system configured to cause the UE to:
receive, based at least in part on being in an active state, a low power scheduling request (LP-SR) resource allocation;
transition to a sleep state; and
transmit an LP-SR using an LP-SR resource in the LP-SR resource allocation.

2. The UE of claim 1, wherein each LP-SR resource in the LP-SR resource allocation is associated with a respective low power wakeup signal (LP-WUS) monitoring occasion.

3. The UE of claim 1, wherein a first respective location of each LP-SR resource in the LP-SR resource allocation is associated with a second respective location of a respective low power wakeup signal (LP-WUS) monitoring occasion.

4. The UE of claim 1, wherein the processing system is configured to cause the UE to:
obtain an indication that uplink data is ready for an uplink transmission,
wherein, to transmit the LP-SR, the processing system is configured to cause the UE to transmit the LP-SR based at least in part on the indication that the uplink data is ready for the uplink transmission.

5. The UE of claim 1, wherein the processing system is configured to cause the UE to:
receive, based at least in part on transmitting the LP-SR, a low power wakeup signal (LP-WUS); and
monitor, based at least in part on receiving the LP-WUS, for an uplink grant indication.

6. The UE of claim 5, wherein the processing system, to cause the UE to monitor for the uplink grant indication, is configured to cause the UE to:
monitor for a physical downlink control channel (PDCCH) in a PDCCH window that is based at least in part on the LP-WUS.

7. The UE of claim 5, wherein the processing system is configured to cause the UE to:
receive a physical downlink control channel (PDCCH) that carries the uplink grant indication and a downlink grant indication;
transmit, during an active time of the UE, an uplink communication using an uplink grant that is specified by the uplink grant indication; and
receive, during the active time used to transmit the uplink communication, a downlink communication using a downlink grant that is specified by the downlink grant indication.

8. The UE of claim 1, wherein the LP-SR resource is a first LP-SR resource in the LP-SR resource allocation, and
wherein the processing system is configured to cause the UE to:
fail to receive a low power wakeup signal (LP-WUS) in an LP-WUS monitoring occasion that is associated with the first LP-SR resource; and
retransmit the LP-SR using a second LP-SR resource in the LP-SR resource allocation.

9. The UE of claim 1, wherein the processing system is configured to cause the UE to:
fail to receive an LP-WUS in an LP-WUS monitoring occasion that is associated with the LP-SR resource;
retransmit the LP-SR N times based at least in part on a failure to receive a respective LP-WUS for each retransmission of the LP-SR, N being an integer;
transition to an active state based at least in part on the failure; and
transmit a scheduling request (SR) based at least in part on the failure.

10. The UE of claim 1, wherein the processing system is configured to cause the UE to:
activate a failure timer based at least in part on transmitting the LP-SR;
fail to receive an LP-WUS prior to expiration of the failure timer;
detect expiration of the failure timer;
transition to an active state based at least in part on the expiration of the failure timer; and
transmit a scheduling request (SR) based at least in part on the expiration of the failure timer.

11. A method of wireless communication performed by a user equipment (UE), comprising:
receiving, based at least in part on being in an active state, a low power scheduling request (LP-SR) resource allocation;
transitioning to a sleep state; and
transmitting an LP-SR using an LP-SR resource in the LP-SR resource allocation.

12. The method of claim 11, wherein each LP-SR resource in the LP-SR resource allocation is associated with a respective low power wakeup signal (LP-WUS) monitoring occasion.

13. The method of claim 11, further comprising:
obtaining an indication that uplink data is ready for an uplink transmission,
wherein transmitting the LP-SR using the LP-SR resource is based at least in part on obtaining the indication that the uplink data is ready for the uplink transmission.

14. The method of claim 11, further comprising:
receiving, based at least in part on transmitting the LP-SR, a low power wakeup signal (LP-WUS); and
monitoring, based at least in part on receiving the LP-WUS, for an uplink grant indication.

15. The method of claim 14, further comprising:
receiving a physical downlink control channel (PDCCH) that carries the uplink grant indication and a downlink grant indication;
transmitting, during an active time of the UE, an uplink communication using an uplink grant that is specified by the uplink grant indication; and
receiving, during the active time used to transmit the uplink communication, a downlink communication using a downlink grant that is specified by the downlink grant indication.

16. The method of claim 11, wherein the LP-SR resource is a first LP-SR resource in the LP-SR resource allocation, and
wherein the method further comprises:
failing to receive a low power wakeup signal (LP-WUS) in an LP-WUS monitoring occasion that is associated with the first LP-SR resource; and
retransmitting the LP-SR using a second LP-SR resource in the LP-SR resource allocation.

17. A non-transitory computer-readable medium storing a set of instructions for wireless communication, the set of instructions comprising:
one or more instructions that, when executed by one or more processors of a user equipment (UE), cause the UE to:
receive, based at least in part on being in an active state, a low power scheduling request (LP-SR) resource allocation;
transition to a sleep state; and
transmit an LP-SR using an LP-SR resource in the LP-SR resource allocation.

18. The non-transitory computer-readable medium of claim 17, wherein the one or more instructions further cause the UE to:
obtain an indication that uplink data is ready for an uplink transmission,
wherein transmitting the LP-SR using the LP-SR resource is based at least in part on obtaining the indication that the uplink data is ready for the uplink transmission.

19. The non-transitory computer-readable medium of claim 17, wherein the one or more instructions further cause the UE to:
receive, based at least in part on transmitting the LP-SR, a low power wakeup signal (LP-WUS); and
monitor, based at least in part on receiving the LP-WUS, for an uplink grant indication.

20. The non-transitory computer-readable medium of claim 19, wherein the one or more instructions further cause the UE to:
receive a physical downlink control channel (PDCCH) that carries the uplink grant indication and a downlink grant indication;
transmit, during an active time of the UE, an uplink communication using an uplink grant that is specified by the uplink grant indication; and
receive, during the active time used to transmit the uplink communication, a downlink communication using a downlink grant that is specified by the downlink grant indication.
